(19) United States
(12) Patent Application Publication
(10) Pub. No.: US 2023/0139693 A1
(43) Pub. Date: May 4, 2023

(54) AIR VEHICLE AND METHOD FOR OPERATING THE AIR VEHICLE

(71) Applicant: ISRAEL AEROSPACE INDUSTRIES LTD., Lod (IL)

(72) Inventors: Nissim Hofi, Halamish (IL); Shuki Rynski, Newe Daniel (IL)

(21) Appl. No.: 17/911,815

(22) PCT Filed: May 23, 2021
(86) PCT No.: PCT/IL2021/050597

§ 371 Date: Sep. 15, 2022

(30) Foreign Application Priority Data
May 27, 2020 (IL) 274998

(51) Int. Cl. B64C 29/00; G05D 1/08; B64C 27/24; B64C 19/00

(52) U.S. Cl. CPC B64C 29/0033; G05D 1/0858; B64C 27/24; B64C 19/00; B64C 11/001

(57) ABSTRACT

An air vehicle is provided including a body, a primary propulsion unit mounted to the body, and a set of secondary propulsion units mounted to the body. The primary propulsion unit includes at least one primary rotor and is configured for providing at least a majority of a total vertical thrust required for enabling vectored thrust flight to the air vehicle. The set includes at least three said secondary propulsion units. The set is configured for providing variable vectored thrust at least sufficient for generating control moments for stability and control of the air vehicle. The set of secondary propulsion units includes at least one secondary propulsion unit pivotably mounted with respect to the body about a respective pivot axis and configured for pivoting about the pivot axis between at least a vertical mode and a horizontal mode, to respectively provide a thrust vector at least in a range between a vertical thrust vector and a horizontal thrust vector. The pivotable secondary propulsion units are further configured for providing at least horizontal propulsion to the air vehicle at least when not in vertical mode.

### TECHNOLOGICAL FIELD

The presently disclosed subject matter relates to air vehicles, in particular for air vehicles having VTOL capability, and also to methods for operating such air vehicles.

### BACKGROUND

Air vehicles having VTOL (vertical takeoff and landing) capability are well known, and such air vehicles commonly perform military and or operations.

Many different configurations for such VTOL air vehicles are known in the art, and at least some such air vehicles are also configured as unmanned aerial vehicles (UAVs).

### GENERAL DESCRIPTION

According to a first aspect of the presently disclosed subject matter there is provided an air vehicle comprising:
a body;
a primary propulsion unit mounted to the body, said primary propulsion unit including at least one primary rotor and configured for providing at least a majority of the total vertical thrust required for enabling vectored thrust flight to the air vehicle;
a set of secondary propulsion units mounted to the body, said set of secondary propulsion units including at least three said secondary propulsion units, said set of secondary propulsion units being configured for providing variable vectored thrust at least sufficient for generating control moments for stability and control of the air vehicle;
wherein said set of secondary propulsion units comprises at least one said secondary propulsion unit pivotably mounted with respect to said body about a respective pivot axis and configured for pivoting about said pivot axis between at least a vertical mode and a horizontal mode, to respectively provide a thrust vector at least in a range between a vertical thrust vector and a horizontal thrust vector, and wherein said pivotable secondary propulsion units are further configured for providing at least horizontal propulsion to the air vehicle at least when not in vertical mode.

According to the first aspect of the presently disclosed subject matter there is also provided an air vehicle comprising:
a body;
a primary propulsion unit mounted to the body, said primary propulsion unit including at least one primary rotor and configured for providing at least a majority of the total vertical thrust required for enabling vectored thrust flight to the air vehicle;
a set of secondary propulsion units mounted to the body, said set including at least three said secondary propulsion units, said set of secondary propulsion units being configured for providing variable vectored thrust at least sufficient for generating control moments for stability and control of the air vehicle;
wherein said set of secondary propulsion units comprises at least two said secondary propulsion units pivotably mounted with respect to said body about a respective pivot axis and configured for pivoting about said pivot axis between at least a vertical mode and a horizontal mode, to respectively provide a thrust vector at least in a range between a vertical thrust vector and a horizontal thrust vector, and wherein said pivotable secondary propulsion units are further configured for providing at least horizontal propulsion to the air vehicle at least when not in vertical mode.

For example, the primary propulsion unit is longitudinally located at or near a center of gravity of the air vehicle.

Additionally or alternatively, for example, the primary propulsion unit is transversely located at or near a center of gravity of the air vehicle.

Additionally or alternatively, for example, the primary propulsion unit is configured for being capable of exclusively providing said total vertical thrust. Alternatively, for example, the primary propulsion unit is configured for being capable of providing at least 50% of said total vertical thrust, for example up to 55% of said total vertical thrust, or for example up to 60% of said total vertical thrust, or for example up to 65% of said total vertical thrust, or for example up to 70% of said total vertical thrust, or for example up to 75% of said total vertical thrust, or for example up to 80% of said total vertical thrust, or for example up to 85% of said total vertical thrust, or for example up to 90% of said total vertical thrust, or for example up to 95% of said total vertical thrust, or for example up to 99s % of said total vertical thrust.

Additionally or alternatively, for example, the primary propulsion unit is configured for selectively varying thrust generated thereby.

Additionally or alternatively, for example, said at least one respective primary rotor comprising a plurality of primary rotor blades and a respective primary rotor shaft. For example, the primary propulsion system is configured to provide a primary thrust vector aligned with an axis of rotation of the respective primary rotor shaft. Additionally or alternatively, for example, said primary propulsion unit includes two said primary rotors, in contra-rotating relationship with respect to one another, each said rotor comprising a respective plurality of primary rotor blades and a respective primary rotor shaft. Additionally or alternatively, for example, said primary rotor blades each have a fixed and uniform blade pitch with respect to the respective primary rotor shaft. Additionally or alternatively, for example, said primary propulsion unit is configured for providing thrust control by changing rpm of the at least one primary rotor.

Additionally or alternatively, for example, the air vehicle comprises at least three, for example four, said secondary propulsion units. For example, the air vehicle has only four said secondary propulsion units.

Additionally or alternatively, for example, at least two said secondary propulsion units are pivotably mounted with respect to said body about a respective said pivot axis.

Additionally or alternatively, for example, each said secondary propulsion unit is mounted to the body via a respective boom. For example, said booms project outwardly from said body. Additionally or alternatively, for example, said booms are of fixed length; alternately, each said booms is reversibly extending between a retracted configuration and an extended configuration, wherein in the retracted configuration, the respective secondary propulsion unit is closer to the body than in the extended configuration.

Additionally or alternatively, for example, the secondary propulsion units are configured to provide together up to 50% of said total vertical thrust, for example up to 45% of said total vertical thrust, or for example up to 40% of said total vertical thrust, or for example up to 35% of said total vertical thrust, or for example up to 30% of said total vertical thrust, or for example up to 25% of said total vertical thrust, or for example up to 20% of said total vertical thrust, or for example up to 15% of said total vertical thrust, or for example up to 10% of said total vertical thrust, or for example up to 5% of said total vertical thrust, or for example up to 1% of said total vertical thrust.

Additionally or alternatively, for example, the secondary propulsion units are configured to selectively provide control moments to the air vehicle in at least one of pitch, yaw and roll.

Additionally or alternatively, for example, said primary propulsion unit has a respective primary rotor disc diameter that is significantly larger than a respective secondary rotor disc diameter of each said secondary propulsion units. For example, said primary rotor disc diameter that is at least 5 times larger than said secondary rotor disc diameter of each said secondary propulsion units. Additionally or alternatively, for example, a perimeter circumscribed by said primary rotor disc diameter vertically encloses the respective secondary rotor axes of each of the secondary propulsion units; alternatively, a perimeter circumscribed by said primary rotor disc diameter vertically encloses the respective the secondary rotor discs of each of the secondary propulsion units.

Additionally or alternatively, for example, said air vehicle has an absence of fixed wings configured for providing aerodynamic flight to said air vehicle.

According to a second aspect of the presently disclosed subject matter there is provided a control system to control operation of an air vehicle, wherein the air vehicle comprises a primary propulsion unit, and a set of at least three secondary propulsion units including a plurality of tiltable secondary propulsion units, the control system comprising a processing unit and associated memory configured to generate one or more commands comprising at least one first command operable to control a magnitude of a thrust of the primary propulsion unit to generate a majority of a total vertical thrust required for enabling vectored thrust flight to the air vehicle, at least one second command operable to control a variable thrust of the secondary propulsion units, the second command controlling a magnitude of a thrust of one or more of the secondary propulsion units, and a tilt of each of one or more of the tiltable secondary propulsion units along at least one pivot axis, to provide a thrust vector at least in a range between a vertical thrust vector and a horizontal thrust vector.

Additionally or alternatively, for example, the control system is configured to control an attitude of the air vehicle according to a desired attitude, wherein the at least one second command controlling the secondary propulsion units is operable to control the secondary propulsion units to generate control moments for controlling the air vehicle according to the desired attitude.

Additionally or alternatively, for example, the control system is configured to generate a command inducing a tilt of one or more of the secondary propulsion units to generate a thrust vector including a horizontal thrust component, the command inducing a decrease of a magnitude of a total vertical thrust generated by the secondary propulsion units, and generate a command to increase the total vertical thrust of the primary propulsion unit, to compensate at least partially said decrease.

Additionally or alternatively, for example, the air vehicle includes front tiltable secondary propulsion units and rear tiltable secondary propulsion units, and the control system is configured to generate a command to tilt both the front tiltable secondary propulsion units and the rear tiltable secondary propulsion units to each generate a thrust vector including a horizontal thrust component, thereby inducing a decrease of a magnitude of a total vertical thrust generated by the secondary propulsion units, and to generate a command to increase a total vertical thrust of the primary propulsion unit to compensate at least partially said decrease.

Additionally or alternatively, for example, the control system is configured to generate at least one command operable to increase a total vertical thrust generated by the air vehicle to induce ascent of the air vehicle, wherein a majority of the increase of the total vertical thrust results from an increase of a total vertical thrust generated by the secondary propulsion units.

Additionally or alternatively, for example, the control system is configured to generate at least one command operable to increase a magnitude of a total vertical thrust of the secondary propulsion units, while maintaining a vertical thrust of the primary propulsion unit, for controlling an ascent of the air vehicle.

Additionally or alternatively, for example, the air vehicle comprises forward secondary propulsion units and rear secondary propulsion units, and the control system is configured to perform at least one of (1) and (2):

(1) generate a command inducing a tilt of forward secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold,

(2) generate a command inducing a tilt of rear secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold.

Additionally or alternatively, for example, the control system is configured to vary a ratio between a rpm of secondary rotors of forward secondary propulsion units and a rpm of secondary rotors of rear propulsion units to maintain a pitch of the air vehicle below a predefined threshold.

Additionally or alternatively, for example, the control system is configured to generate at least one command operable to decrease a total vertical thrust generated by the air vehicle to induce descent of the air vehicle, wherein a majority of the decrease of the total vertical thrust results from a decrease of a total vertical thrust generated by the secondary propulsion units.

Additionally or alternatively, for example, the system is configured to generate at least one command operable to decrease a magnitude of a total vertical thrust of the secondary propulsion units, while maintaining a vertical thrust of the primary propulsion unit, for controlling a descent of the air vehicle.

Additionally or alternatively, for example, the secondary propulsion units are shifted from the primary propulsion unit along a yaw axis of the air vehicle.

Additionally or alternatively, for example, the control system is configured to generate a command to control a vertical thrust of the primary propulsion unit to at least balance weight of the air vehicle.

Additionally or alternatively, for example, the control system is configured to, during a take-off of the air vehicle: generate at least one first command controlling total vertical thrust of the primary propulsion unit to be at least equal to a first threshold, generate at least one second command to control a tilt of each of the tiltable secondary propulsion units to generate a vertical thrust vector, and control a magnitude of a total vertical thrust of the secondary propulsion units to be above a second threshold, wherein the first threshold and the second threshold correspond to a flight mode in which a total vertical thrust of the air vehicle balances a weight of the air vehicle.

Additionally or alternatively, for example, the control system is configured to, during a descent of the air vehicle: generate at least one first command controlling total vertical thrust of the primary propulsion unit to be at least equal to a first threshold, generate at least one second command to control a tilt of each of the tiltable secondary propulsion units to generate a vertical thrust vector, and control a magnitude of a total vertical thrust of the secondary propulsion units to be below a second threshold, wherein the first threshold and the second threshold correspond to a flight mode in which a total vertical thrust of the air vehicle balances a weight of the air vehicle.

Additionally or alternatively, for example, the control system is configured to generate at least one command to maintain an altitude of the air vehicle, the at least one command being operable to control: a magnitude of a vertical thrust generated by the primary propulsion unit, and a magnitude and a tilt of the secondary propulsion units to generate a total vertical thrust by the secondary propulsion units, wherein the vertical thrust of the primary propulsion unit and the total vertical thrust of the secondary propulsion units balance weight of the air vehicle.

Additionally or alternatively, for example, the control system is configured to generate a command of the secondary propulsion units to selectively provide control moments to the air vehicle in at least one of pitch, yaw and roll.

Additionally or alternatively, for example, each said secondary propulsion unit is mounted to a body of the air vehicle via a respective boom, and the control system is configured to generate a command to control a length of one or more booms of the air vehicle to generate control moments controlling the air vehicle.

Additionally or alternatively, for example, the control system is configured to perform at least one of (1), (2) and (3): (1) control a pitch of the air vehicle, the control including generating a command to vary a ratio of combined vertical thrust provided by aft secondary propulsion units relative to a combined vertical thrust provided by forward propulsion units; (2) control a roll of the air vehicle, the control including generating a command to vary a ratio of combined vertical thrust provided by port secondary propulsion units relative to a combined vertical thrust provided by starboard propulsion units; (3) control a yaw of the air vehicle, the control including generating a command to vary a direction of a thrust vector provided by port secondary propulsion vectors relative of a thrust vector provided by starboard secondary propulsion units.

Additionally or alternatively, for example, there is provided an air vehicle comprising a primary propulsion unit, and a set of at least three secondary propulsion units including a plurality of tiltable secondary propulsion units, and the control system as described above.

According to a third aspect of the presently disclosed subject matter there is provided a method of controlling operation of an air vehicle, wherein the air vehicle comprises a primary propulsion unit, and a set of at least three secondary propulsion units including a plurality of tiltable secondary propulsion units, the method comprising, by a processing unit and associated memory operatively coupled to the air vehicle: generating at least one first command operable to control a magnitude of a thrust of the primary propulsion unit to generate a majority of a total vertical thrust required for enabling vectored thrust flight to the air vehicle, generating at least one second command operable to control a variable thrust of the secondary propulsion units, the second command controlling a magnitude of a thrust of one or more of the secondary propulsion units, and a tilt of each of one or more of the tiltable secondary propulsion units along at least one pivot axis, to provide a thrust vector at least in a range between a vertical thrust vector and a horizontal thrust vector.

Additionally or alternatively, for example, the method comprises controlling an attitude of the air vehicle according to a desired attitude, wherein the at least one second command controlling the secondary propulsion units is operable to control the secondary propulsion units to generate control moments for controlling the air vehicle according to the desired attitude.

Additionally or alternatively, for example, the method comprises generating a command inducing a tilt of one or more of the secondary propulsion units to generate a thrust vector including a horizontal thrust component, the command inducing a decrease of a magnitude of a total vertical thrust generated by the secondary propulsion units, and

generating a command to increase the total vertical thrust of the primary propulsion unit, to compensate at least partially said decrease.

Additionally or alternatively, for example, the method comprises performing at least one of (1) and (2):

(1) generating at least one command operable to increase a total vertical thrust generated by the air vehicle to induce ascent of the air vehicle, wherein a majority of the increase of the total vertical thrust results from an increase of a total vertical thrust generated by the secondary propulsion units,

(2) generating at least one command operable to decrease a total vertical thrust generated by the air vehicle to induce descent of the air vehicle, wherein a majority of the decrease of the total vertical thrust results from a decrease of a total vertical thrust generated by the secondary propulsion units.

Additionally or alternatively, for example, the method comprises performing at least one of (1) and (2):

(1) generating at least one command operable to increase a magnitude of a total vertical thrust of the secondary propulsion units, while maintaining a vertical thrust of the primary propulsion unit, for controlling an ascent of the air vehicle;

(2) generating at least one command operable to decrease a total vertical thrust generated by the air vehicle to induce descent of the air vehicle, wherein a majority of the decrease of the total vertical thrust results from a decrease of a total vertical thrust generated by the secondary propulsion units.

Additionally or alternatively, for example, the air vehicle comprises forward secondary propulsion units and rear secondary propulsion units, the method comprises performing at least one of (1) and (2):

(1) generating a command inducing a tilt of forward secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold,

(2) generating a command inducing a tilt of rear secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold.

Additionally or alternatively, for example, the method can include performing various operations described above with respect to the control system.

According to a fourth aspect of the presently disclosed subject matter there is provided a non-transitory storage device readable by a machine, tangibly embodying a program of instructions executable by the machine to perform operations of controlling operation of an air vehicle, wherein the air vehicle comprises a primary propulsion unit, and a set of at least three secondary propulsion units including a plurality of tiltable secondary propulsion units, the operations comprising, by the machine:

generating at least one first command operable to control a magnitude of a thrust of the primary propulsion unit to generate a majority of a total vertical thrust required for enabling vectored thrust flight to the air vehicle,

generating at least one second command operable to control a variable thrust of the secondary propulsion units, the second command controlling:

a magnitude of a thrust of one or more of the secondary propulsion units, and

a tilt of each of one or more of the tiltable secondary propulsion units along at least one pivot axis, to provide a thrust vector at least in a range between a vertical thrust vector and a horizontal thrust vector.

Additionally or alternatively, for example, the program of instructions is executable by the machine to perform various operations as described with respect to the control system and/or the method of control of the air vehicle.

### BRIEF DESCRIPTION OF THE DRAWINGS

In order to better understand the subject matter that is disclosed herein and to exemplify how it can be carried out in practice, examples will now be described, by way of non-limiting example only, with reference to the accompanying drawings, in which:

FIG. 1(a) is a front/top/side isometric view of a first example of the air vehicle of the invention according to a first aspect of the presently disclosed subject matter, and in which the booms are in retracted configuration; FIG. 1(b) is a front/top/side isometric view of the example FIG. 1(a), and in which the booms are in extended configuration.

FIG. 2(a) is a side view of the example FIG. 1(a), with the booms are in retracted configuration; FIG. 2(b) is a side view of the example FIG. 1(b), with the booms are in extended configuration.

FIG. 3(a) is a front view of the example FIG. 1(a), with the booms are in retracted configuration; FIG. 3(b) is a front view of the example FIG. 1(b), with the booms are in extended configuration.

FIG. 4(a) is a top view of the example FIG. 1(a), with the booms are in retracted configuration; FIG. 4(b) is a top view of the example FIG. 1(b), with the booms are in extended configuration.

FIG. 5 is a side view of the example FIG. 2(b), illustrating tilting of the pivoting secondary propulsion units; FIG. 5(a) shows in side view several angular positions of the pivoting secondary propulsion unit of FIG. 5; FIG. 5(b) shows in side view several angular positions of an alternative variation of the example of the pivoting secondary propulsion unit of FIG. 5; FIG. 5(c) is a schematic representation of an embodiment of a control system of the air vehicle; FIG. 5(d) is a flow chart of a method of controlling the air vehicle using a control system of the air vehicle; FIG. 5(e) is a flow chart of a method of controlling an ascent of the air vehicle using a control system of the air vehicle; FIG. 5(f) is a flow chart of a method of controlling a descent of the air vehicle using a control system of the air vehicle; FIG. 5(g) is a flow chart of a method of controlling take-off of the air vehicle; FIG. 5(h) is a flow chart of another method of controlling take-off of the air vehicle; FIG. 5(i) is a flow chart of a method of controlling landing of the air vehicle; FIG. 5(j) is a flow chart of another method of controlling landing of the air vehicle; FIG. 5(k) is a flow chart of another method of controlling hovering of the air vehicle.

FIG. 6(a) is a front/top/side isometric view of the example of FIG. 1(a) providing pitch control in vectored thrust flight mode; FIG. 6(b) is a front/top/side isometric view of the example of FIG. 1(a) providing roll control in vectored thrust flight mode; FIG. 6(c) is a front/top/side isometric view of the example of FIG. 1(a) providing yaw control in vectored thrust flight mode; FIG. 6(d) is a flow chart of a method of controlling pitch of the air vehicle; FIG. 6(e) is a flow chart of a method of controlling roll of the air vehicle; FIG. 6(f) is a flow chart of a method of controlling yaw of the air vehicle.

FIG. 7 is a front/top/side isometric view of the example of FIG. 1(a) providing forward/aft motion in vectored thrust flight mode; FIG. 7(a) is a flow chart of a method of controlling forward motion of the air vehicle; FIG. 7(b) is a flow chart of an embodiment of the method of FIG. 7(a); FIG. 7(c) is a flow chart of another embodiment of the method of FIG. 7(a); FIG. 7(d) is a flow chart of a method of controlling lateral motion of the air vehicle.

FIG. 8(a) is a front/top/side isometric view of an alternative variation of first example of the example FIG. 1(a), in which the booms are in retracted configuration.

FIG. 8(b) is a front/top/side isometric view of the example FIG. 8(a), and in which the booms are in extended configuration; FIG. 8(c) is an aft/top/side isometric view of the example FIG. 8(a), in which the booms are in retracted configuration; FIG. 8(d) is an aft/top/side isometric view of the example FIG. 8(a), and in which the booms are in extended configuration.

FIG. 9(a) is a front/top/side isometric view of a second example of the air vehicle of the invention according to the first aspect of the presently disclosed subject matter, and in which the booms are in retracted configuration; FIG. 9(b) is a front/top/side isometric view of the example FIG. 1(a), and in which the booms are in extended configuration.

### DETAILED DESCRIPTION

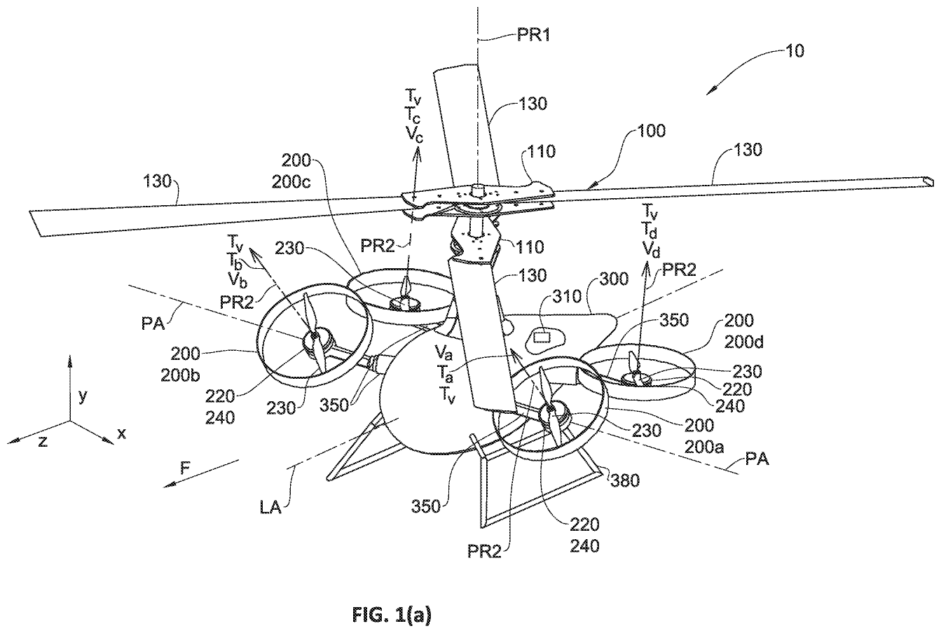

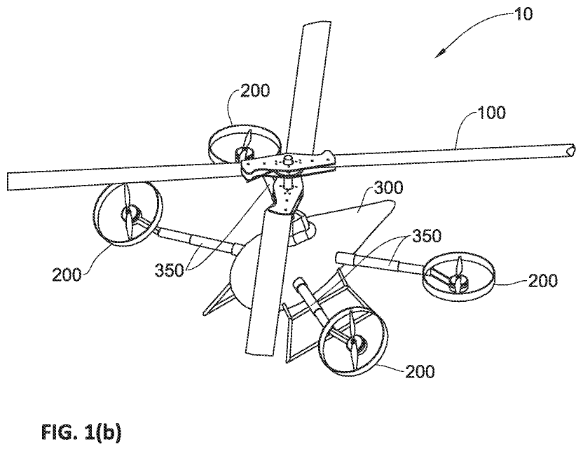

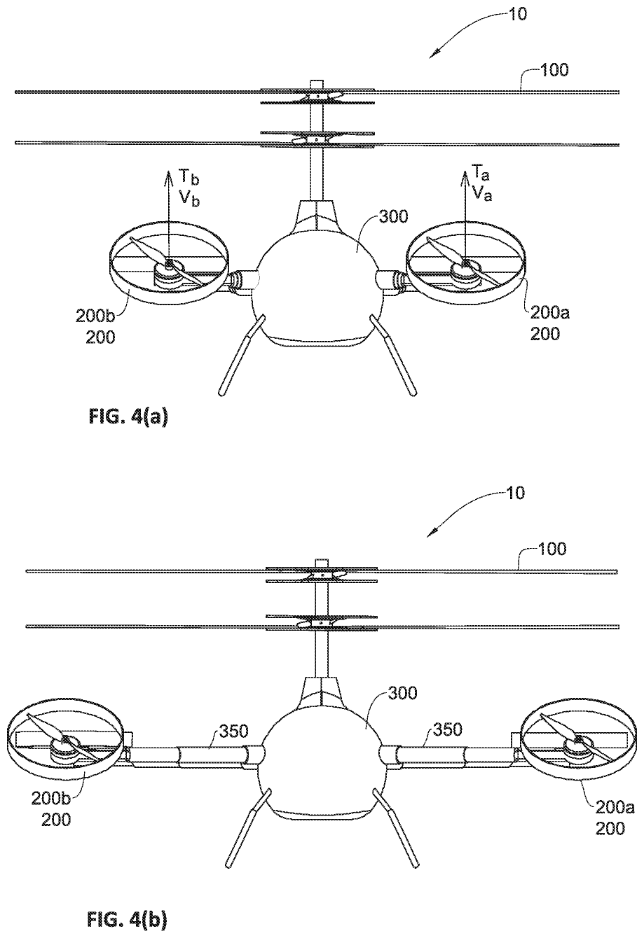

Referring to FIGS. 1(a), 1(b), 2(a), 2(b), 3(a), 3(b), 4(a), 4(b), a first example of an air vehicle according to a first aspect of the presently disclosed subject matter, is generally designated with reference numeral 10, and comprises a body 300 in the form of a fuselage, a primary propulsion unit 100 and a set of secondary propulsion units 200.

The primary propulsion unit 100 is mounted to the body 300. The primary propulsion unit 100 is configured for providing vectored thrust flight to the air vehicle 10.

By “vectored thrust flight” is meant flight capability that does not depend on, nor receives, any lift contribution from aerodynamic lift generated by fixed wings, but rather that the lift for the air vehicle is provided exclusively via vertical thrust generated by primary propulsion unit 100 either by itself, or in combination with the set of secondary propulsion units 200.

It is to be noted that at least in this example and in alternative variations thereof, the air vehicle 10 has an absence of fixed wings (that are otherwise configured for providing aerodynamic lift to the air vehicle sufficient to provide aerodynamic flight capability to the air vehicle).

It is to be noted that at least in this example and in alternative variations thereof, the air vehicle 10 has an absence of an empennage. However, in other alternative variations thereof, the air vehicle 10 can have an empennage.

The air vehicle 10 has a roll axis z aligned with the longitudinal axis LA of the body 300 and the direction of forward flight F, a pitch axis x, and a yaw axis y.

The air vehicle 10 in at least this example is configured as an autonomous subsonic unmanned air vehicle (AUAV), though in alternative variations of this embodiment the air vehicle can be configured as a subsonic unmanned air vehicle (UAV), or as a manned air vehicle and/or configured as a transonic air vehicle.

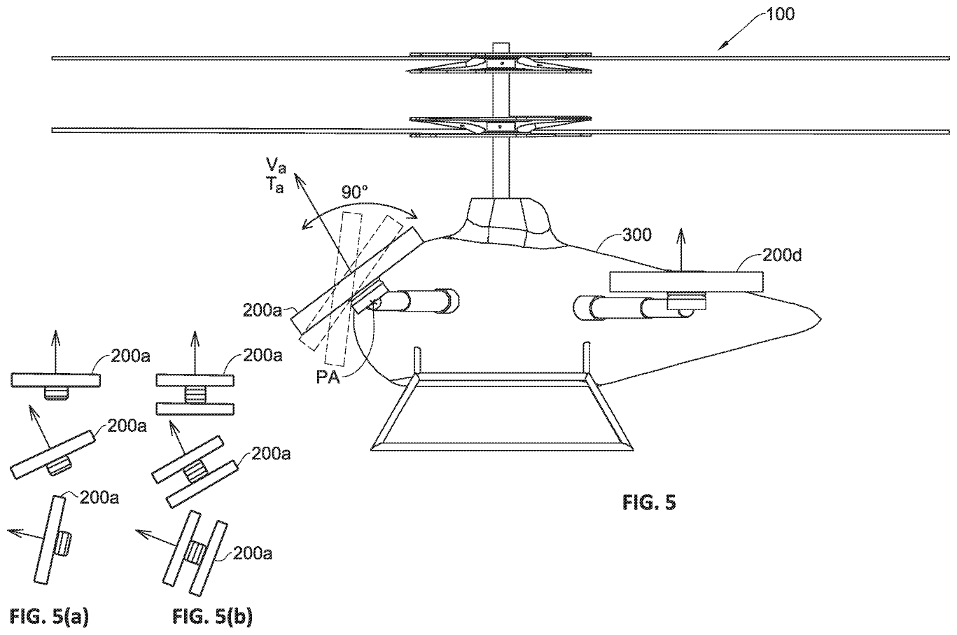

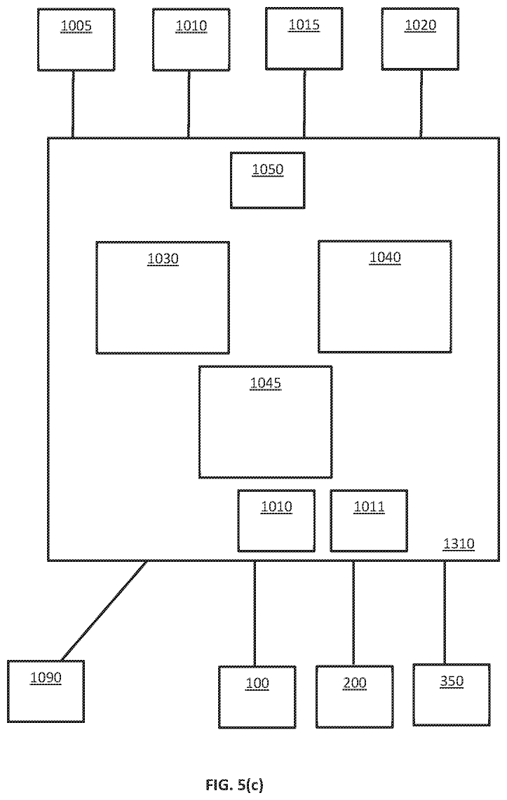

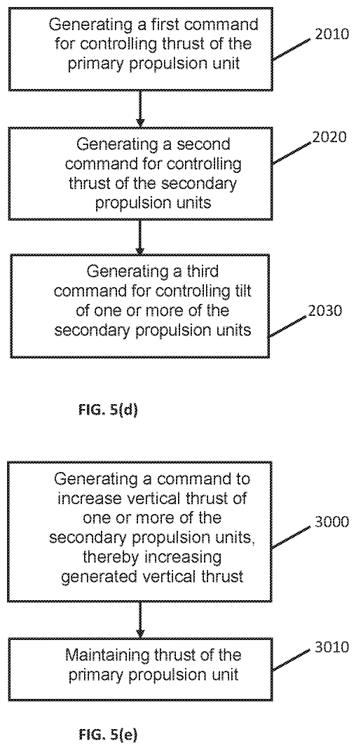

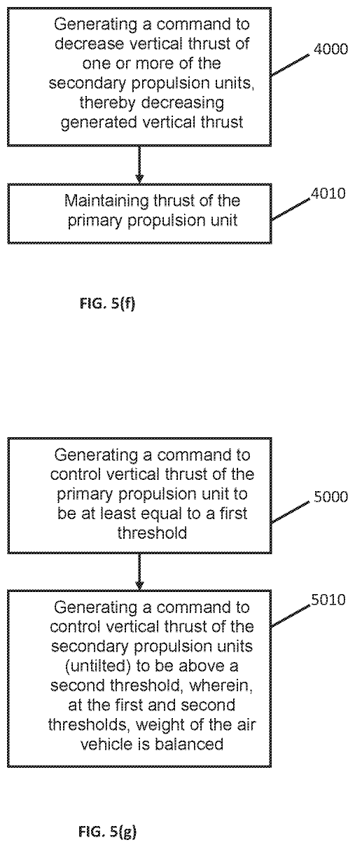

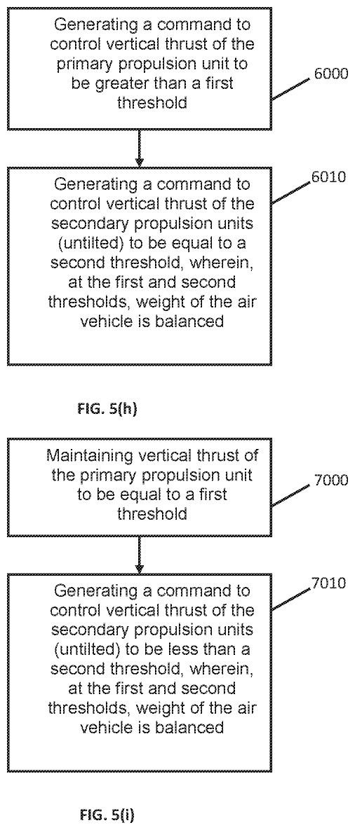

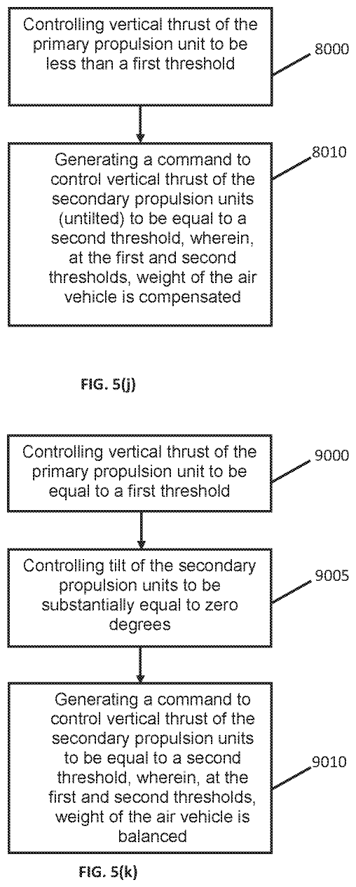

A control system 310 is configured for providing control of the air vehicle 10. As explained hereinafter, control system 310 can ensure autonomous control of the air vehicle 10 and/or can be controlled through a remote control. Control system 310 is further discussed hereinafter with reference to FIG. 5(c).

The longitudinal axis LA is generally parallel to the direction of forward flight F.

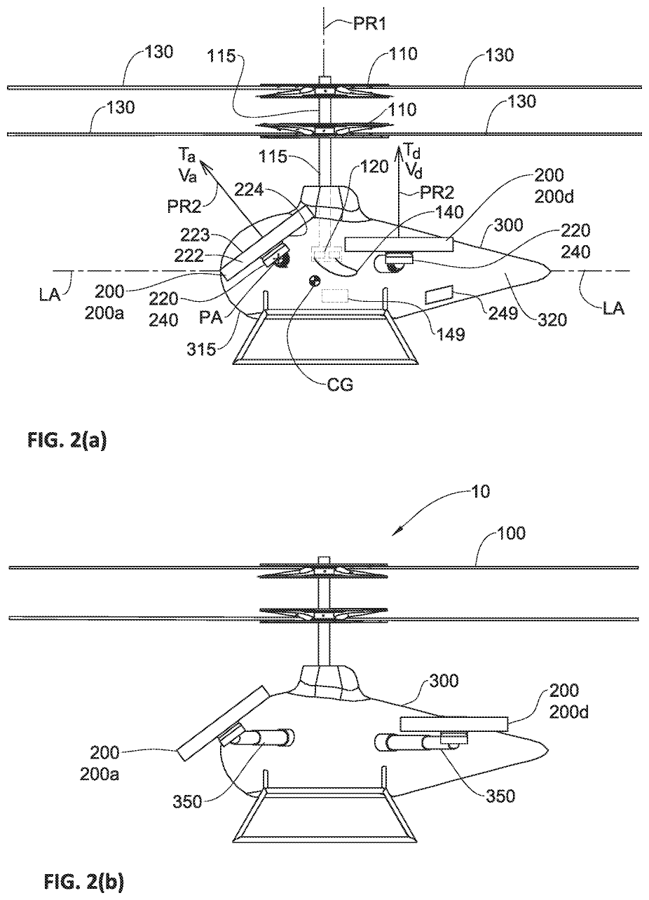

The primary propulsion unit 100 includes at least one primary rotor 110, rotatable about a primary rotor axis PR1. Each primary rotor 110 comprises at least two primary rotor blades 130. The primary propulsion unit 100 also includes a primary driver 120 (FIG. 2(a)) operatively coupled to the at least one primary rotor 110. The primary driver 120 is configured for selectively turning the at least one primary rotor 110 (i.e., including the primary rotor blades 130 thereof) about primary rotor axis PR1 to thereby enable the primary rotor blades 130 of the at least one primary rotor 110 to generate lift for providing at least part of the thrust required for vectored thrust flight for the air vehicle 10. While in at least this example, the primary driver 120 is located inside the body 300, in alternative variations of this example, the primary driver 120 can be mounted to an outside of the body 300.

In at least this example, and referring in particular to FIG. 2(a), the primary propulsion unit 100 includes two counter rotating primary rotors 110, rotatable in mutually opposite directions (and typically at similar rotational speeds) about the primary rotor axis PR1. Each of the two primary rotors 110 has two primary rotor blades 130 mounted to a respective primary rotor shaft 115, and in this example the two primary rotor shafts 115 can be concentric with respect to one another. In alternative variations of this example, each primary rotor 110 has more than two primary rotor blades 130, for example 3, 4, or more than 4 primary rotor blades.

In at least this example, and referring in particular to FIG. 2(a), the primary driver 120 includes two engines or motors 140 configured for turning the rotating primary rotors 110, and furthermore, each of the two motors 140 is an electric motor coupled to a respective primary rotor 110 and also coupled to a suitable electrical supply such as batteries 149 for example, which can be accommodated in the body 300, for example. In alternative variations of this example, at least one said engine or motor 140 can be provided and configured for turning the two primary rotors 110, for example via suitable gears. In yet other alternative variations of this example, the primary propulsion unit 100 includes a single primary rotors 110 and at least one said engine or motor coupled thereto. In yet other alternative variations of any one of these examples, at least one said engine or motor 140 can include a fuel engine, for example an internal combustion engine or a turbojet type engine, or, at least one said engine or motor 140 can include a hybrid engine.

In at least this example, the primary propulsion unit 100 is configured for selectively changing the level of thrust T1 generated thereby by changing the rpm of the two primary rotors 110. In general terms: the higher the rpm, the greater the level of thrust T1 generated; the lower the rpm, the lower the level of thrust T1 generated.

In at least this example, the blade pitch of the primary rotor blades 130 of each of the two primary rotors 110 (with respect to the respective rotor shaft 115) is uniform and fixed, and cannot be changed during operation of the primary propulsion unit 100 when generating thrust T1.

In at least one alternative variation of this example, the primary propulsion unit 100 is configured for selectively changing the level of thrust T1 generated thereby by additionally or alternatively uniformly changing the collective blade pitch of the primary rotor blades 130 of one or each of the two primary rotors 110, within a range of pitch angles between a minimum pitch and a maximum pitch consistent with providing attached flow over the respective primary rotor blades 130: the higher the blade pitch (within the pitch range), the greater the level of thrust T1 generated. By collective blade pitch is meant that the blade pitch of all the primary rotor blades 130 are concurrently changed in the same manner. For example, each one of the two primary rotors 110 comprises a respective collective pitch plate coupled to the rotors via pitch links, wherein the collective pitch plate can be translated axially along the primary rotor axis PR1 to thereby change the blade pitch of all the respective primary rotor blades 130 in the same manner with respect to the respective rotor shaft 115. Thus, each respective collective pitch plate is always orthogonal to the primary rotor axis PR1

According to this aspect of the presently disclosed subject matter the primary propulsion unit 100 is configured with an absence of cyclic pitch capability, and thus each effective rotor disc corresponding to each primary rotor 110 (and each respective collective pitch plate) is always orthogonal to the primary rotor axis PR1. In other words, the primary propulsion unit 100 is configured for changing the collective blade pitch of the primary rotor blades 130 of one or each of the two primary rotors 110 only in a uniform manner—i.e., the pitch angle of all the primary rotor blades 130 can only be changed in a uniform manner, in which all the primary rotor blades 130 always have the pitch angle relative to one another. The actual value of the pitch angle, shared by all the primary rotor blades 130, can of course vary.

In at least this example, and referring in particular to FIG. 2(a), the body 300 has a longitudinal axis LA, and an aerodynamic shape, comprising a generally rounded forward section 315 and a faired aft section 320. Furthermore, while in at least this example the body 300 has generally circular body transverse cross-sections orthogonal to the longitudinal axis LA. In alternative variations of this example the body transverse cross-sections can be oval, elliptical, super-elliptical, oblate, polygonal or of any other suitable shape. In at least this example, the center of gravity CG of the air vehicle 10 is at or close to (i.e., near of) the primary rotational axis PR1. By “close to” or “near of” is meant that the center of gravity CG and the primary rotational axis PR1 can be offset from one another, longitudinally and/or transversely by, corresponding spacings that are corresponding percentages of the longitudinal length and transverse width, respectively of the air vehicle 10, wherein such percentages are less than any one of: 25%, 20%, 15%, 10%, 5%, 3%, 2%, 1%.

In at least this example, the body 300 comprises an undercarriage 380, configured for absorbing and/or damping touchdown forces associated with landing the air vehicle 10 on a ground surface. In at least this example, the undercarriage 380 is fixed and comprises four legs 381 in outwardly and downwardly splayed configuration, a pair of legs 381 on the port side, and a pair of legs 381 on the starboard side, and a respective ground contact strut 382 joined to the free ends of the lags 381 in each pair of legs 381. In alternative variations of this embodiment, the undercarriage can instead be retractable, and/or, the air vehicle can be provided with a different undercarriage arrangement to that illustrated in the figures—for example wheel undercarriage, skis or pontoons. In yet other alternative variations of this embodiment, the air vehicle can be provided without an undercarriage and comprises an alternative arrangement for cushioning a landing or is configured for landing onto a suitable cradle or soft cushioning material in VTOL configuration.

In at least this example, the air vehicle 10 can further comprises a payload for example in the form of a surveillance package, comprising image acquisition system. For example, such an image acquisition system can include, for example, one or more optical or IR imaging cameras which are pointing in the general Earth direction. In alternative variations of this example, the payload can be omitted, or alternatively can be located at a different position on the body, or alternatively a different payload can be provided, internally or externally of the body; such a payload can comprise, for example, sensors, radar systems, COMINT equipment, electronic countermeasures, stores, delivery system therefor, and so on.

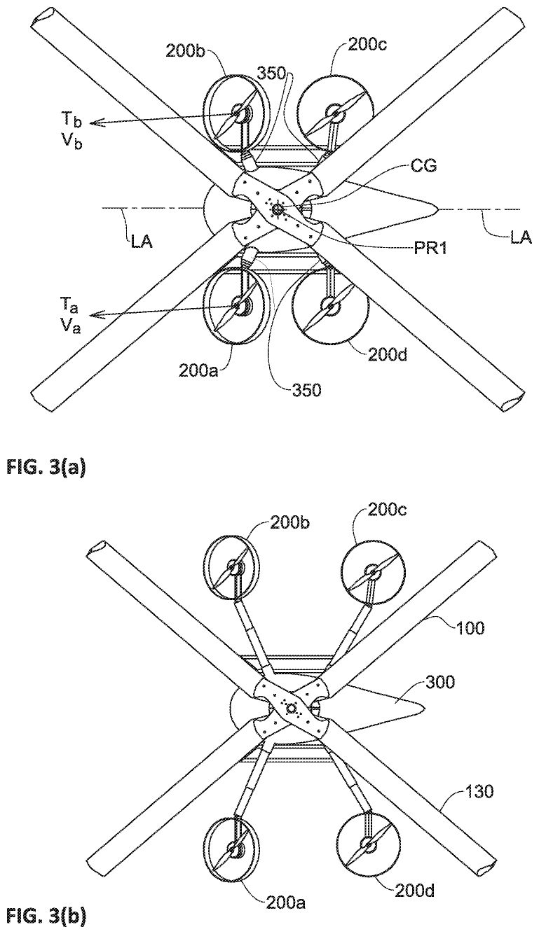

In at least this example, and referring to FIG. 3(a) in particular, the set of secondary propulsion units 200 includes four said propulsion units 200 arranged in closed polygonal arrangement enclosing the primary rotor axis PR1 when viewed in a direction parallel to the primary rotor axis PR1. In at least this example, the closed polygonal arrangement is in the form of a quadrilateral, for example any one of a square, rectangle or trapezium.

The four said propulsion units 200 are mounted to the body 300 via four respective booms 350 that radially project outwardly from the body 300.

In at least one implementation of this example, the booms 350 are fixedly disposed spatially with respect to the body 300 and are not of fixed length. For example, the booms 350 are selectively, and optionally reversibly, extendible between a retracted configuration and an extended configuration, for example the booms 350 are telescopic, ach boom 350 having a plurality of telescopic elements 355 that nest with respect to one another. In the retracted configuration (FIGS. 1(a), 2(a), 3(a), 4(a)) the booms are of a minimum axial length, while in the extended configuration (FIG. 1(b), 2(b), 3(b), 4(b)) the booms are of a maximum axial length. Suitable boom actuators (not shown) are provided in the air vehicle 10 and operatively coupled to the booms 350 to enable each of the booms 350 to be selectively retracted or extended, independently of one another, whether the air vehicle is on the ground or in vectored flight mode.

For example, the air vehicle 10 can include a plurality of attitude sensors, for example accelerometers, to determine the attitude of the air vehicle 10 in pitch, roll and yaw, and operatively connected to the controller 310, which is also operatively connected to the boom actuators. Responsive to any sudden change in the attitude of the air vehicle 10, for example arising from ejecting an asymmetrical load (for example external stores not mounted at the center of gravity CG), the boom actuators can extend or retract to change the moment arm of the respective second propulsion units 200 to thereby trim the air vehicle 10.

In alternative variations of this example, while the booms are selectively extendible and retractable, any changes in the boom lengths can only be performed when the air vehicle is grounded.

In at least one other implementation of this example, the booms 350 fixedly disposed spatially with respect to the body 300 and are of fixed length.

In yet other alternative variations of this example, the booms (which can be of fixed length or of variable length) can be non-fixedly disposed spatially with respect to the body 300. For example, each boom 350 is pivotable or otherwise movable with respect to the body 300 between a stowed position and a deployed position. In the deployed position, the booms 350 are radially project outwardly from the body 300, while in the stowed position, the booms 350 are in closer proximity to the longitudinal axis LA of the body 300 to provide a more compact configuration for the air vehicle 10, which can be useful for storage and transport.

Referring in particular to FIG. 1(a) and FIG. 2(a), each secondary propulsion unit 200 includes at least one secondary rotor 210, rotatable about a respective secondary rotor axis PR2. Each secondary rotor 210 of each secondary propulsion unit 200 comprises at least two secondary rotor blades 230. Each secondary propulsion unit 200 also includes a secondary driver 220 operatively coupled to the respective at least one secondary rotor 210. The secondary driver 220 is configured for selectively turning the respective at least one secondary rotor 210 about a respective secondary rotor axis PR2 to thereby generate a respective thrust vector TV for providing stability and control, and in some cases forward propulsion for the air vehicle 10, as will become clearer herein. In alternative variations of this example, each secondary rotor 210 has more than two secondary rotor blades 230, for example 3, 4 or more than 4 secondary rotor blades 230.

It is to be noted that at least in this example, the primary propulsion unit 100 has a respective primary rotor disc diameter (defined by the diameter of the disc circumscribed by the tip of the primary rotor blades 130) that is significantly larger than the respective secondary rotor disc diameter of each of the secondary propulsion units 200 (defined by the diameter of the respective disc circumscribed by the tip of the secondary rotor blades 230). For example, the primary rotor disc diameter is larger than the secondary rotor disc diameter of each of the secondary propulsion units by a factor N, wherein N can be any one of: up to 2, up to 3, up to 4, up to 5, up to 6, up to 7, up to 8, up to 9, up to 10, more than 10.

It is also to be noted that at least in this example, a perimeter circumscribed by the primary rotor disc diameter of the primary propulsion unit 100 vertically encloses the secondary rotor axes PR2 of each of the secondary propulsion units 200 at least when the booms 350 are retracted, and optionally also when the booms 350 are extended.

It is also to be noted that at least in this example, a perimeter circumscribed by the primary rotor disc diameter of the primary propulsion unit 100 vertically encloses the secondary rotor discs of each of the secondary propulsion units 200 at least when the booms 350 are retracted, and optionally also when the booms 350 are extended.

In at least this example, the secondary driver 220 includes one engine or motor 240 configured for rotating the secondary rotors 210.

In at least this example, each secondary propulsion unit 200 is configured as a ducted fan unit, comprising motor 240 centrally mounted within a respective duct 222 via internal struts (not shown), the duct 222 having a duct inlet 223 and a duct outlet 224. Each motor 240 is thus coupled to and powers a respective secondary rotor 210, which in this example is in the form of a fan having a plurality of secondary rotor blades 230 in fixed pitch relationship.

In operation, each secondary propulsion unit 200 generates a respective thrust vector TV in the general direction from the respective duct outlet 224 to the respective duct inlet 223, as the secondary propulsion unit 200 have an absence of fixed vanes and/or an absence of movable vanes for controlling the thrust vector of the respective secondary propulsion unit 200, though in alternative variations of this embodiment at least one secondary propulsion unit 200 can comprise some fixed vanes.

For each secondary propulsion unit 200, each respective motor 240 is an electric motor coupled to the respective secondary rotor 210 and also coupled to a suitable electrical supply, such as batteries 249 for example, which can be accommodated in the body 300, for example. In alternative variations of this example, at least one said engine or motor 240 can be provided and configured for turning the respective secondary rotor 210 of each secondary propulsion unit 200, for example via suitable gears. In yet other alternative variations of any one of these examples, at least one said engine or motor 240 can include a fuel engine, for example an internal combustion engine or a turbojet type engine, or, at least one said engine or motor 240 can include a hybrid engine.

In at least this example, the respective secondary rotor 210 of two of the secondary propulsion unit 200 are configured for rotating in one direction, while the respective secondary rotor 210 of the other two secondary propulsion unit 200 are configured for rotating in the opposite direction.

In alternative variations of the above example, in which each secondary propulsion units 200 comprises a single rotating rotor, all the secondary propulsion units 200 can be instead configured as mutually co-rotating (i.e., the rotors all turn in the same direction as viewed from the top of the air vehicle 10) and are of similar construction (except for the mounting arrangement to the air vehicle), simplifying manufacture and logistics, and reducing manufacturing and ownership costs.

In alternative variations of this example, at least one of the secondary propulsion units 200 (configured as a ducted fan unit) can comprise a plurality of fans driven by the respective motor.

In yet other alternative variations of this example, at least one of the secondary propulsion units 200 can be configured as a ductless secondary propulsion units 200, i.e., omitting the duct 222.

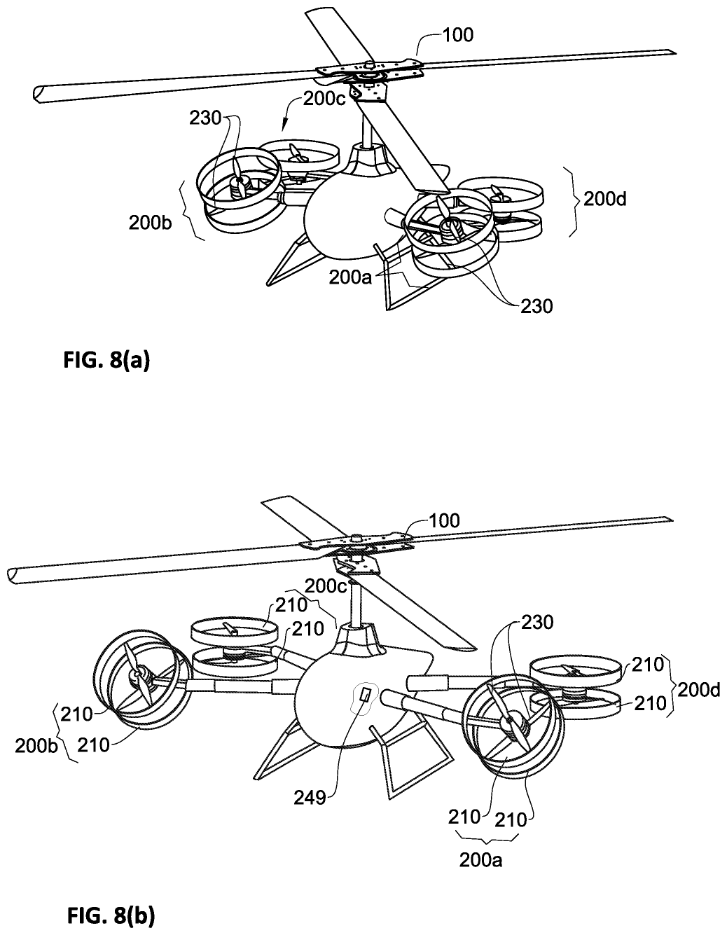

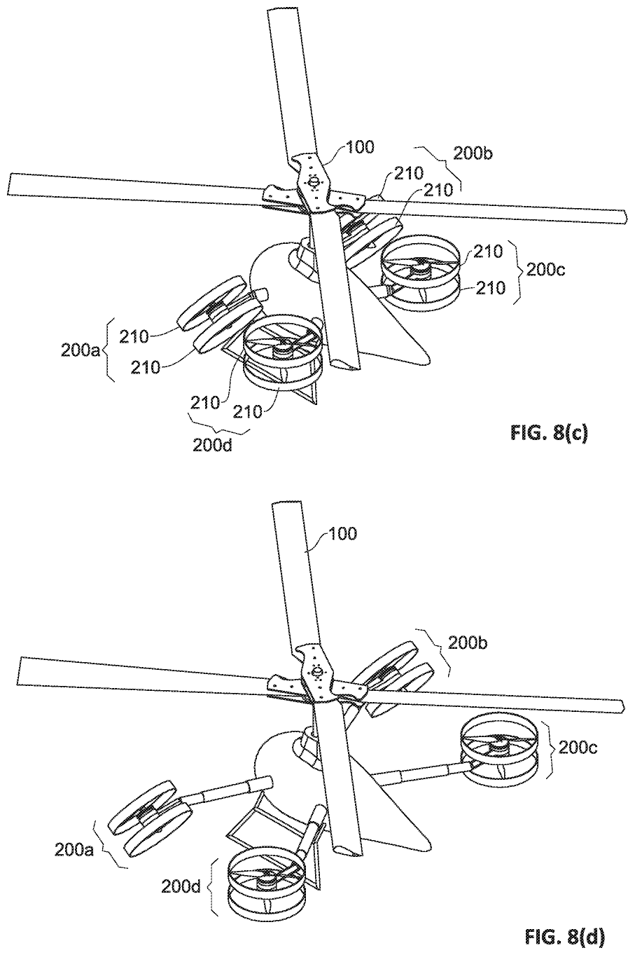

In at least some alternative variations of this example, and referring to FIGS. 8(a), 8(b), 8(c) and 8(d), and also FIG. 5(b) each secondary propulsion unit 200 includes two counter rotating primary rotors 210 (each mounted in a respective duct), rotatable in mutually opposite directions (and typically at similar rotational speeds) about a respective secondary rotor axis PR2. Each of the two secondary rotors 210 of each secondary propulsion unit 200 has two secondary rotor blades 230 mounted to a respective secondary rotor shaft. In this example, for each secondary propulsion unit 200 the respective two secondary rotor shafts are co-axial with respect to one another. In alternative variations of this example, each secondary rotor 210 has more than two secondary rotor blades 230, for example 3, 4 or more than 4 secondary rotor blades 230. In at least this example, the secondary driver 220 includes two engines or motors 240 configured for rotating the secondary rotors 210. For each secondary propulsion unit 200, each of the respective two motors 240 is an electric motor coupled to the respective secondary rotor 210 and also coupled to a suitable electrical supply, such as batteries 249 for example, which can be accommodated in the body 300, for example. In alternative variations of this example, at least one said engine or motor 240 can be provided and configured for turning the respective two secondary rotors 210 of each secondary propulsion unit 200, for example via suitable gears. In yet other alternative variations of any one of these examples, at least one said engine or motor 240 can include a fuel engine, for example an internal combustion engine or a turbojet type engine, or, at least one said engine or motor 240 can include a hybrid engine.

Referring again to the first example illustrated in FIGS. 1(a), 1(b), 2(a), 2(b), 3(a), 3(b), 4(a), 4(b), in at least this example, each secondary propulsion unit 200 is optionally configured for selectively changing the level of thrust vector T₂ generated thereby by changing the rpm of the respective secondary rotor 210. In general terms: the higher the rpm, the greater the level of thrust T₂ generated; the lower the rpm, the lower the level of thrust T₂ generated.

According to this aspect of the presently disclosed subject matter, at least one said secondary propulsion unit 200 is pivotably mounted with respect to said body 300 about a respective pivot axis PA. Furthermore, the respective pivoting secondary propulsion unit 200 is also configured for pivoting about the respective pivot axis PA between at least a vertical mode and a horizontal mode, to respectively provide a respective vertical thrust vector and a respective horizontal thrust vector. Furthermore, each respective pivotable secondary propulsion units are further configured for providing at least horizontal propulsion to the air vehicle 10 at least in horizontal mode.

In at least this example, two of the four secondary propulsion unit 200 are pivotably mounted (also interchangeably referred to herein as “tiltably mounted”) with respect to the body 300, each about a respective pivot axis PA, and the remaining two secondary propulsion unit 200 are fixedly mounted with respect to the body 300, to provide respective thrust only in vertical mode. In particular, each of the two tiltable secondary propulsion unit 200 is pivotably mounted at the free end of the respective boom 350 about a respective pivot axis PA.

In at least this example, the set of secondary propulsion units 200 is configured as part of the propulsion system for the air vehicle 10, and also as a stability and control system for the air vehicle 10.

Thus, in at least this example, and referring in particular to FIG. 3(a), the set of secondary propulsion units 200 comprises a pair of forward-mounted pivotable (tiltable) secondary propulsion units 200 (respectively designated herein also with the reference numerals 200a, 200b respectively), and two, aft-mounted, non-tiltable secondary propulsion units 200 (respectively designated herein also with the reference numerals 200c, 200d respectively), in quadrilateral spatial arrangement in plan view enclosing the center of gravity CG and the primary rotor axis PR1 of the air vehicle 10.

In at least this example, the respective motors 240 are configuring for tilting together with the respective secondary rotor 210, in each of the tiltable secondary propulsion units 200a, 200b.

In alternative variations of this example, the two aft-mounted, non-tiltable secondary propulsion units 200 can be replaced with a single aft-mounted, non-tiltable secondary propulsion unit 200, and thus the set of secondary propulsion units 200 comprises three secondary propulsion units 200 in such an example.

In yet other alternative variations of this example, the set of secondary propulsion units 200 can include more than four secondary propulsion units 200, for example 5, 6, 7, 8, 9, 10, 11 or 12 secondary propulsion units 200, in any suitable arrangement around the primary propulsion unit 100, in which two or more secondary propulsion units 200 can be tiltable secondary propulsion units 200 for example.

In yet other alternative variations of this example, one or two non-tiltable secondary propulsion unit 200 can be provided at the forward end of the air vehicle 10, or at least forward of the center of gravity CG, and a pair of pivotable non-tiltable secondary propulsion unit 200 is provided at the aft end, or at least aft of the center of gravity CG of the air vehicle 10.

The air vehicle 10 further comprises a suitable control system (not shown) for operating the primary propulsion unit 100 and/or the set of secondary propulsion units 200, and such a control system can be part of the controller 310, or can be a separate control system operatively connected to the controller 310. Such a control system can be configured for controlling the magnitudes of each of the thrust T₁ generated by the primary propulsion unit 100, and the thrusts T₂ generated by each of secondary propulsion units 200 (i.e., the individual thrusts Tₐ, T_{b}, T_{c}, T_{d} generated by each of secondary propulsion units 200a, 200b, 200c, 200d, respectively), independently of one another, as well as the thrust vectors Vₐ and V_{b} of the respective thrusts Tₐ, T_{b} generated by the tiltable secondary propulsion units 200a, 200b, respectively, independently of one another.

Unless specified otherwise, the reference numeral 200 refers to each one of the secondary propulsion units 200a, 200b, 200c, 200d.

Referring to FIG. 5, for example, it is evident that in the illustrated example the secondary propulsion units 200a, 200b, 200c, 200d are mounted at a position with respect to the body 300, such as to provide a vertical clearance between the secondary propulsion units 200a, 200b, 200c, 200d and the ground, at least when the air vehicle 10 is parked.

Thus, each secondary propulsion unit 200a, 200b, 200c, 200d is configured for providing an individually controllable thrust level Tₐ, T_{b}, T_{c}, T_{d}, respectively, and each such thrust level Tₐ, T_{b}, T_{c}, T_{d}, can be independently controllably increased or decreased from any suitable datum setting as required.

In the illustrated example of FIGS. 1(a), 1(b), 2(a), 2(b), 3(a), 3(b), 4(a), 4(b), the thrust T₂ generated by each of the four secondary propulsion units 200 can be variably adjusted by independently controlling the rpm of the respective motor 240, and thus of the respective secondary rotors 210. In alternative variations of this example, at least one fan comprises a plurality of variable pitch blades, and the thrust generated by the respective fan can be variably adjusted by controlling the rpm and/or by controlling the pitch of the blades.

The two aft secondary propulsion units 200c, 200d are fixed to the body aft end 320 in fixed spatial orientation with respect thereto, such that the thrust vectors V_{c} and V_{d} of secondary propulsion units 200c, 200d, and the rotational axis PR2 of their respective rotors, are fixed generally parallel to the yaw axis y and pointing in a generally upwards direction with respect to the body 300.

Referring in particular to FIGS. 1(a), 5 and 5(a), the forward port secondary propulsion unit 200a is rotatably mounted with respect to a free end of the respective forward boom 350, for example via journals, to enable the secondary propulsion unit 200a to be reversibly tilted about the respective pivot axis PA with respect to the body 300 about any desired tilt angle α, for example at least between a tilt angle α of zero degrees and 90 degrees. Tilt angle α of zero degrees corresponds to the general vertical thrust position (referred to herein as the respective vertical mode) in which the respective thrust vector Vₐ is substantially parallel to the yaw axis y, and tilt angle α of 90 degrees corresponds to a general longitudinal thrust position (referred to herein as the respective horizontal mode) in which the respective thrust vector Va is substantially parallel to the roll axis z and/or points in direction F. The respective pivot axis PA is substantially parallel to the pitch axis x of the air vehicle 10 and intersects the rotational axis PR2 of the respective rotors 210. Optionally, the secondary propulsion unit 200a can be further tilted about respective pivot axis PA in either direction past the horizontal thrust position or past the vertical thrust position to provide a thrust vector Vₐ at any other suitable angle to the longitudinal axis LA, for example such as to provide any thrust vector including a partial or full downward thrust (angle α between about 90 degrees and about 270 degrees) or a partial or full reverse thrust (angle α between about 0 degrees and about −180 degrees (or between about 180 degrees and about 360 degrees)) i.e. in a direction opposite to direction F.

As the secondary propulsion unit 200a is tilted about the respective pivot axis PA, the thrust Ta generated by the secondary propulsion unit 200a has a respective vertical thrust component Tav (Ta*cosine(α)) and a respective horizontal thrust component Tah (Ta*sine(α)).

Furthermore, the forward starboard secondary propulsion unit 200b is rotatably mounted with respect to the respective forward boom 350, for example via journals, to enable the secondary propulsion unit 200b to be reversibly tilted about the respective pivot axis PA with respect to the body 300 about any desired tilt angle β, for example at least between a tilt angle β of zero degrees and 90 degrees. Tilt angle β of zero degrees corresponds to the general vertical thrust position (referred to herein as the respective vertical mode) in which the respective thrust vector Vb is substantially parallel to the yaw axis y, and tilt angle β of 90 degrees corresponds to a general longitudinal thrust position (referred to herein as the respective horizontal mode) in which the respective thrust vector Vb is substantially parallel to the roll axis z and points in direction F. The respective pivot axis PA is substantially parallel to the pitch axis x of the air vehicle 10 and intersects the rotational axis PR2 of the respective rotors 210. Optionally, the secondary propulsion unit 200b can be further tilted about respective pivot axis PA in either direction past the horizontal thrust position or past the vertical thrust position to provide a thrust vector V_{b} at any other suitable angle to the longitudinal axis LA, for example such as to provide any thrust vector including a partial or full downward thrust (angle β between about 90 degrees and about 270 degrees) or a partial or full reverse thrust (angle β between about 0 degrees and about −180 degrees (or between about 180 degrees and about 360 degrees)) i.e. in a direction opposite to direction F.

As the secondary propulsion unit 200b is tilted about the respective pivot axis PA, the thrust Tb generated by the secondary propulsion unit 200b has a respective vertical thrust component Tbv (Tb*cosine(β)) and a respective horizontal thrust component Tbh (Tb*sine(β)).

In at least this example, the respective pivot axes PA of the forward port secondary propulsion unit 200a and the forward starboard secondary propulsion unit 200b are coaxially aligned.

A suitable drive mechanism (not shown) is provided for independently and controllably driving the tilting of each of the two forward secondary propulsion units 200a, 200b to controllably vary the respective thrust vectors Va and Vb, i.e., the angular position of the respective thrust Tₐ, T_{b} generated by the respective secondary propulsion units 200a, 200b, independently of one another, and to any desired angular position. The drive mechanism is configured for tilting the secondary propulsion units 200a, 200b in a relatively fast manner, and provide very quick and accurate response to tilting commands (in terms of direction and angular displacement) provided by the control system.

In alternative variations of this example, the respective pivot axes PA of the forward port secondary propulsion unit 200a and the forward starboard secondary propulsion unit 200b can be each set at a modest angle to the pitch axis x and/or yaw axis y and/or roll axis z so as to provide a desired thrust vector component along one or more of the roll, pitch or yaw axes, respectively. For example, it can be desired to have the thrust vectors Vₐ and V_{b} in the vertical thrust position in a mutually converging or diverging relationship when viewed from the front of the air vehicle 10. Converging thrust vectors can in some cases delay the formation of an upwash fountain between the front propulsion units, while diverging thrust vectors can in some cases provide natural stability in roll during landing and take-off, for example.

The air vehicle 10 is configured for controllably, selectively and independently varying the thrust vectors Vₐ and V_{b} by changing tilt angle α independently from tilt angle R. This feature provides at least differential and selective tilt control for the thrust vectors generated by each one of the forward secondary propulsion units 200a, 200b, independently of the other forward ducted fan unit. Nevertheless, the forward secondary propulsion units 200a, 200b can also be operated to tilt together in the same direction and through the same or different angular displacement one from the other. Furthermore, the air vehicle 10 is configured for controllably and selectively changing the magnitude of the thrust Tₐ, T_{b}, T_{c}, T_{d} generated by each of the secondary propulsion units 200a, 200b, 200c, 200d, respectively, independently of one another. The air vehicle 10 is also configured for controllably and selectively changing the magnitude of the thrust Tₐ, T_{b}, generated by each of the forward secondary propulsion units 200a, 200b, respectively, independently of one another, and also independently of the magnitude of the respective tilt angles α, β thereof, i.e., of the thrust vectors Vₐ and V_{b}, which can also be controllably and selectively varied independently one from the other.

The total vertical thrust T2_{V} generated by the set of secondary propulsion units 200 is thus:

T2v=Tₐᵥ+T_{bv}+T_{c}+T_{d}

or

T2v=(Tₐ*cosine(α))+(T_{b}*cosine(β))+T_{c}+T_{d}

Thus, the total vertical thrust T_{totV} generated by the air vehicle 10 is:

T_{totV}=T1+T2v

Similarly, the total horizontal thrust T2_{H} generated by the set of secondary propulsion units 200, i.e. by the air vehicle 300, is thus:

T2_{H}=(Tₐ*sine(α))+(T_{b}*sine(β))

The air vehicle 10 is configured for being operated exclusively in vectored thrust flight mode (also referred to herein as “vectored thrust flight”, or as “VTOL operations”), within a vectored thrust flight regime, in which the lift, movement and control of the air vehicle 10 are provided by the primary propulsion unit 100 and the secondary propulsion units 200, under the control of the control system.

For example, for VTOL operations, the forward secondary propulsion units 200a 200b are tilted to the nominal vertical position, in which tilt angles α, β are set at nominally zero degrees, and all four secondary propulsion units 200a, 200b, 200c, 200d provide vertical thrust. In the illustrated embodiment, the center of gravity CG of the air vehicle is located generally centrally with respect to the four secondary propulsion units 200a, 200b, 200c, 200d (see FIG. 3(a)), and thus the four secondary propulsion units 200a, 200b, 200c, 200d can generate nominally the same thrust levels Tₐ, T_{b}, T_{c}, T_{d}, for VTOL take-off. At the same time, it is to be noted that for VTOL operations the primary propulsion unit 100 also provides a vertical thrust T1.

It is to be noted that in alternative variations of this embodiment, where the center of gravity CG is located closer to or further away from the aft secondary propulsion units 200c, 200d than with respect to the forward secondary propulsion units 200a, 200b, and the ratio of the thrust provided by the aft secondary propulsion units 200c, 200d relative to the forward secondary propulsion units 200a, 200b is correspondingly such as to provide pitch balance to the air vehicle. The relative thrust split between the aft secondary propulsion units 200c, 200d relative to the forward secondary propulsion units 200a, 200b, can also be controlled to offset a longitudinal shift in the position of the CG, for example related to the location, size or absence of the payload. Additionally or alternatively, the relative thrust split between the two forward secondary propulsion units 200a, 200b, or between the port secondary propulsion units 200a, 200c, as compared with the starboard secondary propulsion unit, 200b, 200d can also be controlled to offset a lateral shift in the position of the CG that is for example inherent in the air vehicle design or that is related to the location, size or absence of the payload—for example where a stores on one side of the body 300 is jettisoned while retaining a similar stores on the other side of the body 300.

In any case, VTOL operations of the primary propulsion unit 100 and of the secondary propulsion units 200a, 200b, 200c, 200d, allows the air vehicle 10 to vertically take off and to vertically land, to hover over an area, and also to move in a forward or aft direction, and/or to move in a port or starboard side direction, and/or to increase or decrease the altitude of the air vehicle 10, and/or to provide pitch, yaw and roll control to the air vehicle 10.

Attention is drawn to FIG. 5(c), which includes a schematic representation of an embodiment of a control system 1310 (referred to as 310 beforehand) of the air vehicle 10.

Control system 1310 includes a processing unit 1010 and an associated memory 1011. Various modules depicted in the control system 1310 can be implemented using the processing unit 1010 and the associated memory 1011.

As shown, control system 1310 is operable to receive data from various sensors, such as a position sensor 1005 (e.g. GPS, etc.), a velocity sensor 1010, an altimeter 1015, attitude sensor 1020 (configured to provide data informative of at least one of a pitch, yaw and roll of the air vehicle 10). This list is not limitative and other sensors can communicate with control system 1310.

Control system 1310 can include a first controller 1030 configured to control operation of the primary propulsion unit 100 of the air vehicle 10. In particular, the first controller 1030 can generate command(s) for controlling magnitude of the thrust of the primary propulsion unit 100. The command can include e.g. a command setting a value for a rpm of at least one primary rotor 110 of the primary propulsion unit 100.

In some examples, the command can include a command to change the collective blade pitch of the primary rotor blades 130 of one or each of the two primary rotors 110.

Control system 1310 includes a second controller 1040 configured to control operation of each of the secondary propulsion units 200. The second controller 1040 can generate a command which is common for all secondary propulsion units 200, and/or can generate a command specific to each of the secondary propulsion units 200.

The command generated by the second controller 1040 can include a command for controlling a magnitude of a thrust of each of the secondary propulsion units 200. As mentioned above, this can include controlling a rpm of a secondary rotor 210 of each of the secondary propulsion unit 200.

For the secondary propulsion units 200 which are tiltable, the command generated by the second controller 1040 can include a command for controlling tilt of these secondary propulsion units 200. This command can include e.g. a tilt angle (according to the pitch axis, and/or according to additional axes if the secondary propulsion units 200 can be tilted according to other axes than the pitch axis). This command can be transmitted to a drive mechanism of each of the tiltable secondary propulsion units 200.

According to some examples, the secondary propulsion units 200 are shifted from the primary propulsion unit 1000 along a yaw axis of the air vehicle 10 (yaw axis y). In other words, when the air vehicle 10 is on ground, the second propulsion units 200 are shifted from the primary propulsion 100 along a vertical axis corresponding e.g. to the Earth gravity axis. Generally, the second propulsion units 200 are located below the primary propulsion unit 100 along this yaw axis.

In some examples, each of the secondary propulsion units 200 is mounted to a body of the air vehicle 10 via a respective boom 350. Control system 1310 can be configured to generate commands to vary a length of one or more of the respective booms 350, in particular to generate control moments for the air vehicle 10. In some examples, control system 1310 includes a controller 1045 configured to control length of the booms 350 over time.

Control system 1310 can include and/or communicate with a flight controller 1050, which is responsible inter alia of computing desired navigation parameters (such as position, velocity, trajectory, altitude, etc.) of the air vehicle 10 over time. The navigation parameters can be compliant with a flight plan stored in a database (not represented). In other examples, navigation parameters can be controlled by a central control 1090 (e.g. controlled at least partially by a human operator) operatively and remotely coupled with the control system 1310. In some examples, the air vehicle 10 is both controlled using autonomous navigation managed by the control system 1310, and additional navigation commands can be transmitted from the central control 1090 to the control system 1310 (e.g., to correct autonomous navigation of the air vehicle 10).

Depending on the flight plan of the air vehicle 10, the first controller 1030 and the second controller 1040 can generate appropriate commands to control the air vehicle 10 according to a desired flight mode complying with the flight plan, as explained hereinafter.

According to some examples, the air vehicle 10 can also comprise a communication unit (not represented) for emitting and receiving data towards and from the central control 1090 (e.g., remote central control located on ground).

According to some examples, if the air vehicle 10 is at least partly controlled remotely from the central control 1090, at least part of the steps performed by the control system 1310 can be performed by a remote controller (which also operates on a processing unit) located at the central control 1090. The remote controller can communicate with the air vehicle 10 through its communication unit, in order to perform the required steps. It can receive data from the air vehicle, such as data measured by at least a subset of its sensors.

The control system 1310 embedded in the air vehicle 10 can then communicate the orders (signals) received from the remote controller e.g., to actuators of the air vehicle 10.

For example, control of magnitude of the thrust and/or tilt of the primary propulsion unit 100 and/or of the secondary propulsion units 200 can be performed by the remote controller which communicates with the air vehicle 10.

According to some examples, control system 1310 is split into a first control sub-system embedded in the air vehicle 10 and a second control sub-system located in the remote central control 1090.

According to some examples, data computed in the air vehicle 10 (such as by its sensors and/or by its control system 1310) can be displayed at the remote central control 1090, for example for a pilot who can send remote commands to the air vehicle 10.

Attention is now drawn to FIG. 5(d), which describes a possible operation of the control system 1310.

According to some examples, a method can include e.g. obtaining data informative of a desired flight mode of the air vehicle. Examples of flight modes include e.g. take-off, landing, hovering, forward flight, ascent, descent, etc. (see examples hereinafter). The desired flight mode can be computed e.g. by the flight controller 1050. Data informative of the desired flight mode can include desired parameters characterizing the desired flight mode (e.g. desired trajectory, position, velocity, or other parameters over time).

The method includes generating (operation 2010) a first command for controlling a thrust of the primary propulsion unit 100, and in particular, a magnitude of the thrust. As explained above, in some examples, the first command can include a desired rpm for the primary rotor 110 of the primary propulsion unit 100.

The method includes generating (operation 2020) a second command for controlling thrust of one or more of the secondary propulsion units 200. The second command can include a desired rpm for the secondary rotor(s) 210 of the secondary propulsion unit(s) 200.

The method includes generating (operation 2030) a third command for controlling tilt of one or more of the secondary propulsion units 200 which are tiltable.

It should be noted that operations 2010 to 2030 can be performed in a different order than the order depicted in FIG. 5(d), or can be performed concurrently.

In some examples, the second command and the third command can be generated and/or transmitted as a unified command. In some examples, tilt and/or thrust of the propulsion units under control is already compliant with the desired flight mode and is therefore not changed. In this case, an explicit command to maintain current state of thrust and/or tilt can be generated and/or it is prevented from generating a new command for varying thrust and/or tilt.

The first, second and third commands are calibrated to provide a coordinated control of the primary propulsion unit 100, and of the set of secondary propulsion units 200 ensuring operation of the air vehicle 10 according to the desired flight mode. Various examples are provided hereinafter.

According to some examples, a magnitude of a thrust of the primary propulsion unit 100 is controlled to generate a majority of a total vertical thrust (T_{totV}) required for enabling vectored thrust flight to the air vehicle 10. In other words, the primary propulsion unit 100 can provide the main part of the lift of the air vehicle 10.

The secondary propulsion units 200 can also be controlled to generate a total vertical thrust T2_{V} which takes part to the total vertical thrust of the air vehicle 10.

According to some examples, the second and third commands enable a control of a variable thrust of the secondary propulsion units 200 for at least generating control moments controlling the air vehicle 10. For example, as explained hereinafter, the control moments can be used to control attitude of the air vehicle 10 in pitch, roll and/or yaw, in order to reach a desired attitude of the air vehicle 10.

According to some examples, it is possible to use the secondary propulsion units 200 for controlling variation of the altitude of the air vehicle 10, controlling attitude of the air vehicle 10 (along at least one of pitch axis, roll axis, yaw axis), ensuring forward flight, etc. Various examples are provided hereinafter.

According to some examples, vertical thrust generated by the primary propulsion unit 100 is controlled to be sufficient to balance weight of the air vehicle 10. This can be obtained by selecting a sufficient rpm for the primary rotor 100 of the primary propulsion unit 100.

According to some examples, vertical thrust generated by the primary propulsion unit 100 is not sufficient to solely balance weight of the air vehicle 10, and only the total vertical thrust generated by both by the primary propulsion unit 100 and the secondary propulsion units 200 is sufficient to balance weight of the air vehicle 10.

Attention is drawn to FIG. 5(e).

According to some examples, it is desired to induce an ascent of the air vehicle 10 (e.g. from a previous flight mode in which the air vehicle is not ascending, such as in a hovering mode, or in order to increase climbing rate with respect to a previous climbing rate).

A method can include using mainly thrust variation of the secondary propulsion units to control ascent of the air vehicle 10. The secondary propulsion units 200 which are tiltable can be controlled to be untilted (tilt of zero degrees, or less than a predefined threshold), in order to generate a vertical thrust vector. In particular, the method can include generating (operation 3000) a command to increase thrust (vertical thrust) of at least some of the set of the secondary propulsion units 200, while maintaining (operation 3010) thrust of the primary propulsion unit 100.

In some examples, maintaining thrust of the primary propulsion unit 100 can include varying thrust of the primary propulsion unit 100 below a predefined threshold.

The method therefore comprises sending commands to the secondary propulsion units 200 to generate an increase of the thrust generated by each of the secondary propulsion units (with a tilt of zero degrees, or less than a predefined threshold), thereby increasing total vertical thrust generated by the secondary propulsion units 200. As mentioned above, vertical thrust of the primary propulsion unit 100 is maintained or varied less than a threshold.

According to some examples, an increase (ΔT2_{V}=T2_{V}_{_{new}}−T2_{V}_{_{old}}) in the total vertical thrust generated by the secondary propulsion units 200 is larger than an increase (ΔT1=T1_{new}−T1_{old}) in the total vertical thrust generated by the primary propulsion unit 100 (in some examples, ΔT1 is equal to zero)

According to some examples, a majority (or the entirety) of an increase (ΔT_{totV}=T_{totV,new}−T_{totV,old}) in the total vertical thrust (T_{totV}) generated by the primary propulsion unit 100 and the secondary propulsion units 200 following these commands is due to an increase ΔT2_{V} of the vertical thrust generated by the secondary propulsion units 200.

This can be summarized by the following non-limitative equations:

|ΔT_{totV}|=|ΔT_{2V}|+|ΔT1|

|ΔT_{2V}|/|ΔT_{totV}|>0.5

In other words, ascent of the air vehicle 10 is obtained mainly by controlling the secondary propulsion units 200. This is beneficial since varying vertical thrust of the secondary propulsion units 200 is quicker, easier and more flexible than varying vertical thrust of the primary propulsion unit 100.

Attention is drawn to FIG. 5(f).

According to some examples, in order to induce a descent of the air vehicle 10 (during flight of the air vehicle 10), a method can include relying in particular on a vertical thrust variation of the secondary propulsion units 200. This can be performed e.g. for performing descent of the air vehicle 10 from a hovering mode, or in order to further increase a descending rate with respect to a previous descending rate.

A method can include using mainly vertical thrust variation of the secondary propulsion units 200 to control descent of the air vehicle 10. The secondary propulsion units 200 which are tiltable can be controlled to be untilted (tilt of zero degrees, or less than a predefined threshold).

The method can include generating (operation 4000) a command to decrease thrust (vertical thrust) of at least some of the set of the tilted secondary propulsion units 200 while maintaining (operation 4010) thrust of the primary propulsion unit 100.

In some examples, maintaining thrust of the primary propulsion unit 100 can include varying thrust of the primary propulsion unit 100 below a predefined threshold.

The method therefore comprises sending commands to the secondary propulsion units 200 to generate a decrease of the thrust generated by each of the secondary propulsion units (with a tilt of zero degrees, or less than a predefined threshold), thereby decreasing vertical thrust generated by the secondary propulsion units 200. As mentioned above, vertical thrust of the primary propulsion unit 100 is maintained or varied less than a threshold.

According to some examples, a decrease (|ΔT_{2V}|=|T2_{V}_{_{new}}−T2_{V}_{_{old}}) in the total vertical thrust generated by the secondary propulsion units 200 is larger than an decrease (|ΔT1|=|T1_{new}−T1_{old}|) in the total vertical thrust generated by the primary propulsion unit 100 (in some examples, |ΔT1| is equal to zero)

As a majority (or the entirety) of a decrease (|ΔT_{totV}|=|T_{totV,new}−T_{totV,old}|) in the total vertical thrust (|T_{totV}|) generated by the primary propulsion unit 100 and the secondary propulsion units 200 following these commands is due to a decrease |ΔT_{2V}| of the vertical thrust generated by the secondary propulsion units 200.

This can be summarized by the following non-limitative equations:

|ΔT_{totV}|=|ΔT_{2V}|+|ΔT1|

|ΔT_{2V}|/|ΔT_{totV}|>0.5

In other words, descent of the air vehicle 10 is obtained mainly by controlling the secondary propulsion units 200. This is beneficial as already explained above.

### Take-Off Mode

The total thrust T_{totV} provided by the primary propulsion unit 100 (T1) and the four secondary propulsion units 200a, 200b, 200c, 200d (T2_{V}) initially exceeds the take-off weight of the air vehicle 10 to provide an upward velocity, after which the total thrust can be balanced with the weight.

It is to be noted that according to a second aspect of the presently disclosed subject matter, the primary propulsion unit 100 can provide between a majority and all of the total thrust T_{totV} required for take off, and similarly the four secondary propulsion units 200a, 200b, 200c, 200d can together provide from a minority to zero of the total thrust T_{totV} required for take off.

For example, the thrust T1 generated by primary propulsion unit 100 can be between 80% and 90% of the total thrust T_{totV} required for the respective VTOL operations, while the combined vertical thrust T2_{V} generated by the four secondary propulsion units 200a, 200b, 200c, 200d can be correspondingly between 10% and 20% of the total thrust T_{totV} required for the respective VTOL operations.

Attention is drawn to FIG. 5(g) which depicts a possible embodiment of controlling take-off of the air vehicle 10.

Assume that control system 1310 receives information (e.g. by the flight controller 1050) instructing the air vehicle 10 to perform a take-off.

A method can include generating a command to control vertical thrust of the primary propulsion unit 100 to be above a first threshold.

In some examples, the first threshold is selected such that the vertical thrust generated by the primary propulsion unit 100 balances a weight of the air vehicle 10.

As a consequence, since vertical thrust caused by the primary propulsion unit 100 is larger than a weight of the air vehicle 10, the air vehicle 10 takes off.

In some examples, vertical thrust generated by the primary propulsion unit 100 is not sufficient to balance a weight of the air vehicle 10. However, the vertical thrust generated both by the primary propulsion unit 100 and the secondary propulsion units 200 is selected to be greater than the weight of the air vehicle 10. In this flight mode, the tiltable secondary propulsion units can be controlled to have a tilt which ensures generation of a vertical thrust (e.g. the tiltable secondary propulsion units can be controlled along a pitch axis to have a tilt angle equal to zero, this value being not limitative).

For example, assume that when the vertical thrust of the primary propulsion unit 100 is equal to a first threshold, and a total vertical thrust of the secondary propulsion units 200 is equal to a second threshold (for a given tilt of the secondary propulsion units ensuring a thrust at least partially or fully oriented along a vertical direction), a total vertical thrust of the primary propulsion unit 100 and of the secondary propulsion units 200 balances weight of the air vehicle 10.

In order to ensure take-off of the air vehicle 10, the method can comprise generating commands (operation 5000) to control vertical thrust of the primary propulsion unit 100 to be substantially equal to the first threshold, and to control (operation 5010) a total vertical thrust of the second propulsion units 200 to be above the second threshold.

A non-limitative numerical example is provided hereinafter.

Assume that the air vehicle 10 includes four secondary propulsion units 200, including two tiltable secondary propulsion units.

Assume that when power of the primary propulsion unit 100 is equal to 100% (this value is a relative power: 0% corresponds to a state of the primary propulsion unit 100 when it is turned off, and 100% corresponds to the maximal power of the primary propulsion unit 100), and power of each of the secondary propulsion units (the two tiltable propulsion units are in a vertical mode, with a tilt equal to zero degrees) is equal to 50% (relative power), total thrust vector caused by the primary propulsion unit 100 and the secondary propulsion units 200 balance (e.g. is equal to) weight of the air vehicle 10 (hovering position). There is a direct relationship between power of the propulsion unit and corresponding thrust.

In order to ensure take-off of the air vehicle 10, the method can include controlling power of the primary propulsion unit 100 to be equal to 100%, and power of each of the secondary propulsion units 200 to be above 50%.

Another non-limitative numerical example is provided hereinafter.

Assume that the air vehicle 10 includes four secondary propulsion units 200, each of the secondary propulsion units 200 being tiltable.

Assume that when power of the primary propulsion unit 100 is equal to 80% (relative power), and power of each of the four propulsion units 200 (the four tiltable propulsion units are in a vertical mode, with a tilt equal to zero degrees) is equal to 50% (relative power), total thrust vector caused by the primary propulsion unit 100 and the secondary propulsion units 200 balance (e.g. is equal to) weight of the air vehicle 10 (hovering position).

In order to ensure take-off of the air vehicle 10, the method can include controlling power of the primary propulsion unit 100 to be equal to 80%, and power of each of the secondary propulsion units 200 to be above 50%.

Attention is now drawn to FIG. 5(h), which describes another method of controlling take-off of the air vehicle.

Assume that when the vertical thrust of the primary propulsion unit 100 is equal to a first threshold, and a total vertical thrust of the secondary propulsion units is equal to a second threshold (for a given tilt of the secondary propulsion units ensuring a thrust at least partially or fully oriented along a vertical direction), a total vertical thrust of the primary propulsion unit 100 and of the secondary propulsion unit 200 balances (e.g. is equal to) a weight of the air vehicle 10.

In order to ensure take-off of the air vehicle 10, the method can include generating (operation 6000) a command to control vertical thrust of the primary propulsion unit 100 to be above the first threshold, and generating commands (operation 6010) to control (or to maintain) a total vertical thrust of the second propulsion units 200 to be equal to the second threshold.

In other words, control of take-off mainly relies in this embodiment on the primary propulsion unit 100.

A non-limitative numerical example is provided hereinafter.

Assume that the air vehicle 10 includes four secondary propulsion units, including two or more tiltable secondary propulsion units.

Assume that when power of the primary propulsion unit 100 is equal to 80% (relative power), and power of each of the secondary propulsion units 200 (each of the tiltable propulsion units are in a vertical mode, with a tilt equal to zero degrees) is equal to 50% (relative power), the total vertical thrust generated by the primary propulsion unit 100 and the secondary propulsion units 200 balance weight of the air vehicle 10 (hovering position). In order to ensure take-off of the air vehicle 10, the method can include controlling power of the primary propulsion unit 100 to be larger than 80%, and power of each of the secondary propulsion units 200 to be equal to 50%.

Landing Mode For VTOL landing, the total thrust T_{totV} that can be generated by the primary propulsion unit 100 and the four secondary propulsion units 200a, 200b, 200c, 200d is reduced to less than the weight of the air vehicle to provide a downward velocity (after which the thrust can be balanced to the weight), sufficient to at least guarantee a soft landing during regular operation of the air vehicle 10.

Various methods are provided hereinafter for controlling landing of the air vehicle. These methods can be applied mutadis mutandis for performing descent of the air vehicle, without necessarily performing landing of the air vehicle.

Attention is drawn to FIG. 5(i).

Assume that control system 1310 receives information (e.g. by the flight controller 1050) instructing the air vehicle to perform landing.

Assume that when the vertical thrust of the primary propulsion unit 100 is equal to a first threshold, and a total vertical thrust of the secondary propulsion units 200 is equal to a second threshold (for a given tilt of the secondary propulsion units ensuring a thrust at least partially or fully oriented along a vertical direction), a total vertical thrust of the primary propulsion unit 100 and of the secondary propulsion unit 200 balances weight of the air vehicle 10.

In order to ensure landing of the air vehicle 10, the method can comprise maintaining (operation 7000) vertical thrust of the primary propulsion unit 100 to be equal to the first threshold (this can include sending an explicit command to maintain vertical thrust at the first threshold and/or refraining from sending a command to change vertical thrust of the primary propulsion unit 100), and generating a command to control (operation 7010) the total vertical thrust of the second propulsion units 200 to be below the second threshold.

As a consequence, altitude of the air vehicle 10 decreases.

In other words, landing is mainly performed by relying on a decrease of the power of the secondary propulsion units 200.

A non-limitative numerical example is provided hereinafter.

Assume that the air vehicle 10 includes four secondary propulsion units 200, including two tiltable secondary propulsion units.

Assume that when power of the primary propulsion unit 100 is equal to 100% (relative power), and power of each of the secondary propulsion units 200 (the two tiltable propulsion units are in a vertical mode, with a tilt equal to zero degrees) is equal to 50% (relative power), a total vertical thrust generated by the primary propulsion unit 100 and the secondary propulsion units 200 balances weight of the air vehicle (hovering position).

In order to ensure landing of the air vehicle 10, the method can include controlling power of the primary propulsion unit 100 to be maintained equal to 100%, and power of each of the secondary propulsion units 200 to be less than 50%.

Another non-limitative numerical example is provided hereinafter.

Assume that the air vehicle includes 10 four secondary propulsion units, each of the secondary propulsion units being tiltable.

Assume that when power of the primary propulsion unit 100 is equal to 80% (relative power), and power of each of the four propulsion units 200 (the four tiltable propulsion units are in a vertical mode, with a tilt equal to zero degrees) is equal to 50% (relative power), the total vertical thrust generated by the primary propulsion unit 100 and the secondary propulsion units 200 balance (e.g. is equal to) a weight of the air vehicle 10 (hovering position).

In order to ensure landing of the air vehicle 10, the method can include maintaining power of the primary propulsion unit 100 to be equal to 80%, and controlling power of each of the secondary propulsion units 200 to be less than 50%.

Attention is now drawn to FIG. 5(j), which describes another method of controlling landing of the air vehicle 10.

Assume that when the vertical thrust of the primary propulsion unit 100 is equal to a first threshold, and a vertical thrust of the secondary propulsion units 200 is equal to a second threshold (for a given tilt of the secondary propulsion units ensuring a thrust at least partially or fully oriented along a vertical direction), a total vertical thrust of the primary propulsion unit 100 and of the secondary propulsion unit 200 balances (e.g. is equal to) a weight of the air vehicle 10.

In order to ensure landing of the air vehicle 10, the method can include generating (operation 8000) commands to control vertical thrust of the primary propulsion unit 100 to be less than the first threshold, and controlling (operation 8010, this can include maintaining the current vertical thrust) a vertical thrust of the second propulsion units 200 to be equal to the second threshold.

In other words, control of landing mainly relies in this embodiment on the primary propulsion unit 100.

A non-limitative numerical example is provided hereinafter.

Assume that the air vehicle 10 includes four secondary propulsion units 200, including two or more tiltable secondary propulsion units.

Assume that when power of the primary propulsion unit is equal to 80% (relative power), and power of each of the secondary propulsion units (each of the tiltable propulsion units are in a vertical mode, with a tilt equal to zero degrees) is equal to 50% (relative power), the total vertical thrust caused by the primary propulsion unit 100 and the secondary propulsion units 200 balances weight of the air vehicle 10 (hovering position). In order to ensure landing of the air vehicle 10, the method can include controlling power of the primary propulsion unit 100 to be less than 80%, and power of each of the secondary propulsion units 200 to be equal to 50%.

### Hover

Hovering over a fixed area is accomplished by maintaining the combined thrust T_{totV} provided by the primary propulsion unit 100 and by the secondary propulsion units 200a, 200b, 200c, 200d balanced with the weight of the air vehicle 10, and changes in altitude are provided by selectively increasing or decreasing the combined thrust until the desired rate of climb is achieved, after which the combined thrust is against balanced with the air vehicle weight, followed by deceleration to eliminate climb at the desired altitude.

A method of controlling hovering of the air vehicle is depicted in FIG. 5(k). In this flight mode, an altitude of the air vehicle 10 is maintained substantially constant over time. In some examples, this can include maintaining the air vehicle 10 hovering over a fixed area.

The method includes can include generating (operation 9000) commands to control vertical thrust of the primary propulsion unit 100 to be equal to a first threshold. The method can include generating (operation 9005) a command to control all tiltable secondary propulsion units 200 to have a tilt (around the pitch axis) of zero degrees (vertical mode). In some examples, the tilt is selected to be substantially equal to zero (e.g. below a threshold, of e.g. 5 degrees, this value being not limitative). If the tiltable secondary propulsion units 200 are already tilted in compliance with the vertical mode, the method includes maintaining the secondary propulsion units 200 in this position (e.g. by sending an explicit command and/or by refraining from sending a new command).

The method further includes controlling (operation 9010) a vertical thrust of the second propulsion units 200 to be equal to the second threshold.

The first and second thresholds are selected to ensure that the total vertical thrust generated by the primary propulsion unit 100 and the secondary propulsion units 200 balances weight of the air vehicle 10 (hovering position).

As a consequence, altitude of the air vehicle 10 is maintained substantially fixed and the air vehicle 10 can be controlled to be hovering over a fixed area.

### Pitch, Yaw and Roll Control

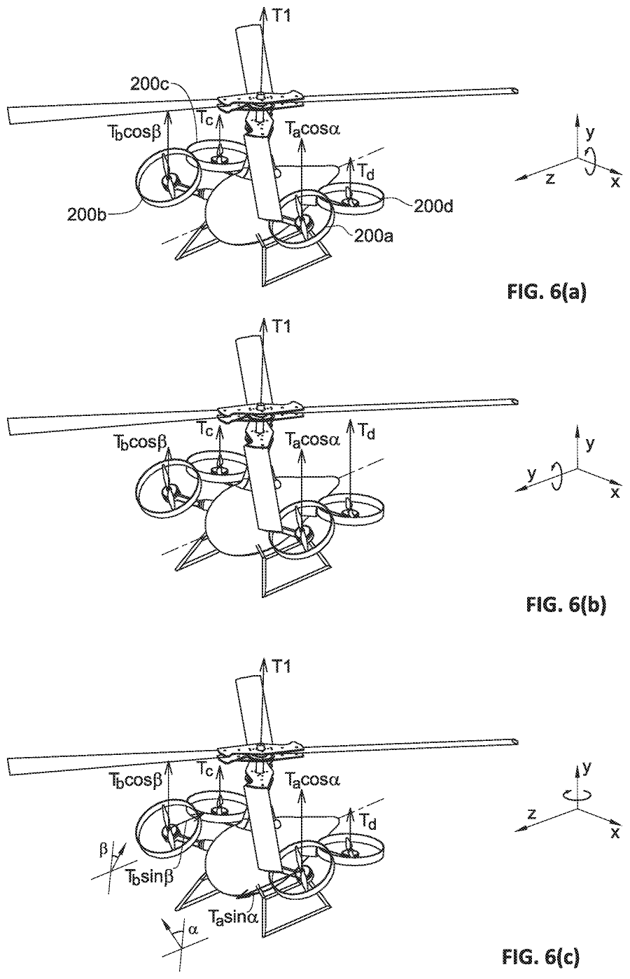

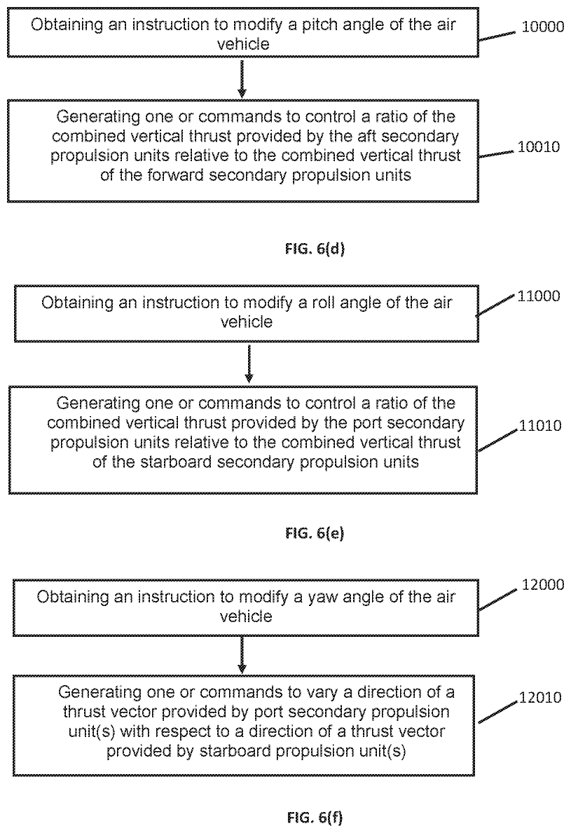

Referring to FIG. 6(a), pitch control of the air vehicle 10 is provided by varying the ratio of the moment provided by the aft secondary propulsion units 200c, 200d relative to the combined moment of the forward secondary propulsion units 200a, 200b. Pitch control can occur when the air vehicle 10 is stationary, i.e., while the tilt angles of the forward secondary propulsion units 200a, 200b, are nominally set at zero degrees. Alternatively, pitch control can occur when the air vehicle 10 is moving forward or backwards, i.e., while the tilt angles of the forward secondary propulsion units 200a, 200b, are non-zero values for α and β, respectively.

Since in this example the moment arms of the four secondary propulsion units 200a, 200b, 200c, 200d is constant at least during the pitch control operation, pitch control is provided by varying the ratio of the combined vertical thrust (T_{c}+T_{d}) provided by the two aft secondary propulsion units 200c, 200d relative to the combined vertical thrust (Tₐ*cos(α)+T_{b}*cos(β)) of the forward secondary propulsion units 200a, 200b—nose up pitch is generated when (T_{c}+T_{d}) is less than (Tₐ*cos(α)+T_{b}*cos(β)), for all values of α and β including zero, and vice versa, i.e., nose down pitch is generated when (T_{c}+T_{d}) is greater than (Tₐ*cos(α)+T_{b}*cos(β)), for all values of α and β including zero.

It is to be noted that concurrently with operating the air vehicle 10 to induce a pitch moment, the total vertical thrust T_{totV} provided by the primary propulsion unit 100 (T1) and the four secondary propulsion units 200a, 200b, 200c, 200d (T2_{V}) is concurrently sufficient to take-off, land or hover, or any other VTOL operation it is currently engaged in.

Attention is drawn to FIG. 6 (d), which depicts a method of controlling pitch of the air vehicle 10.

Assume that control system 1310 receives information (e.g. by the flight controller 1050) instructing the air vehicle 10 to change its pitch and to reach a desired pitch value (operation 10000). In various examples, it is desired to maintain the pitch substantially equal to zero (e.g. equal to zero or below a predefined threshold).

The method can include generating (operation 10010) one or more commands to vary a ratio of the combined vertical thrust (T_{c}+T_{d}) provided by the two aft secondary propulsion units 200c, 200d relative to the combined vertical thrust (Tₐ*cos(α)+T_{b}*cos(β)) of the forward secondary propulsion units 200a, 200b.

The ratio is modified in order to reach the desired pitch value for the air vehicle 10. Determination of the desired ratio can be performed by control system 1310 based on the previous pitch value, and a model (e.g. dynamic model) of the air vehicle 10.

In some examples, this command can include sending a command to modify magnitude of the thrust of the aft secondary propulsion units 200c, 200d.

In some examples, this command can include sending a command to modify magnitude of the thrust (Tₐ, T_{b}) of the forward secondary propulsion units 200a, 200b.

In some examples, this command can include sending a command to modify tilt of the forward secondary propulsion units 200a, 200b.

In some examples, this command can include a combination of one or more of the commands recited above.

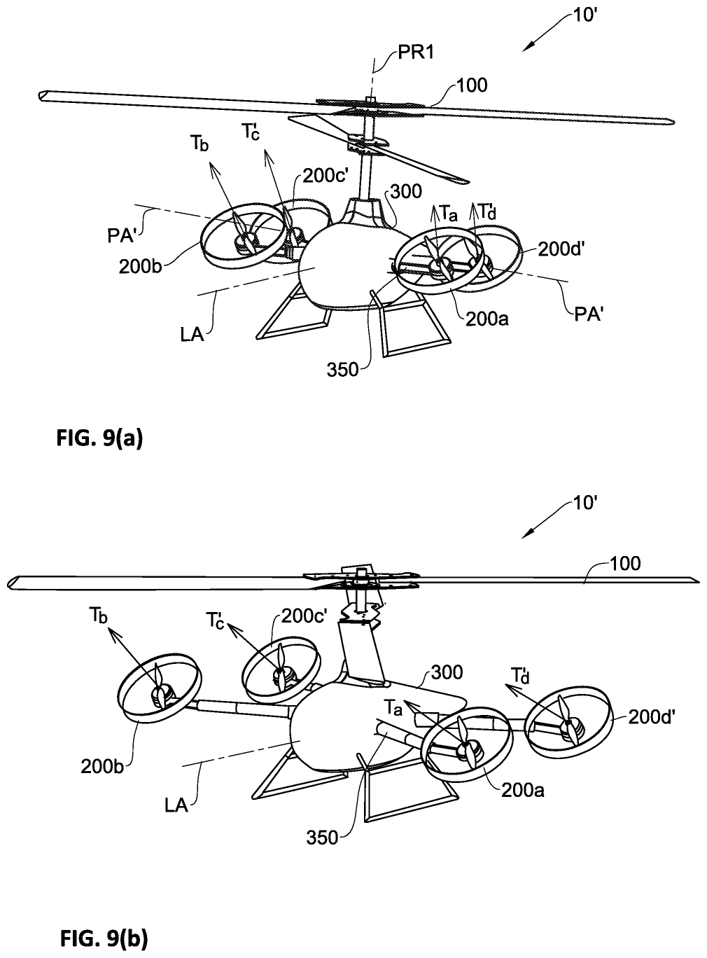

In some examples, the air vehicle 10 can include a different number of secondary propulsion units 200. In addition, a number of secondary propulsion units 200 which are tiltable can be different (as explained hereinafter with reference to the non-limitative example of FIGS. 9(a) and 9(b)). The method described above to control pitch of the air vehicle 10 can be applied mutatis mutandis, and can include generating commands to vary a ratio of the combined vertical thrust (T_{cv}+T_{dv}) provided by the aft secondary propulsion units relative to the combined vertical thrust (Tₐᵥ+T_{bv}) provided by the forward secondary propulsion units. The command can induce a variation of a magnitude of the thrust (Ta, Tb) of the forward secondary propulsion units and/or a variation of a magnitude of the thrust (Tc, Td) of the aft secondary propulsion units and/or a variation of the tilt (α, β, α′, β′) of the tiltable secondary propulsion units to reach the desired pitch angle.

Referring to FIG. 6(b), roll control of the air vehicle 10 is provided by varying the ratio of the roll moment provided by one or both of the port secondary propulsion units 200a, 200d, relative to the roll moment provided by one or both of the starboard secondary propulsion units 200b, 200c.

For example the port forward secondary propulsion unit 200a can have a zero or non-zero tilt angle α, and the starboard secondary propulsion unit 200b can have a zero or non-zero tilt angle β.

Since in this example the moment arms of the four secondary propulsion units 200a, 200b, 200c, 200d is constant at least during the roll control operation, roll control is provided by varying the ratio of the combined vertical thrust (Tₐ*cos(α)+T_{d}) provided by the two port secondary propulsion units 200a, 200d relative to the combined vertical thrust (T_{b}*cos(β)+T_{c}) of the starboard secondary propulsion units 200b, 200c—roll to starboard is generated when (Tₐ*cos(α)+T_{d}) is greater than (T_{b}*cos(β)+T), for all values of α and β including zero, and vice versa, i.e., roll to port is generated when (T_{b}*cos(β)+T_{c}) is greater than (Tₐ*cos(α)+T_{d}) for all values of α and β including zero.

It is to be noted that concurrently with operating the air vehicle 10 to induce a roll moment, the total vertical thrust T_{totV} provided by the primary propulsion unit 100 (T1) and the four secondary propulsion units 200a, 200b, 200c, 200d (T2_{V}) is concurrently sufficient to take-off, land or hover, or any other VTOL operation it is currently engaged in.

Attention is drawn to FIG. 6 (e), which depicts a method of controlling roll of the air vehicle 10.

Assume that control system 1310 receives information (e.g. by the flight controller 1050) instructing the air vehicle 10 to change its roll and to reach a desired roll value (operation 11000).

The method can include generating (operation 11010) one or more commands to vary a ratio of the combined vertical thrust (Tₐ*cos(α)+T_{d}) provided by the two port secondary propulsion units 200a, 200d relative to the combined vertical thrust (T_{b}*cos(β)+T_{c}) of the starboard secondary propulsion units 200b, 200c

The ratio is modified in order to reach the desired roll value for the air vehicle 10. Determination of the desired ratio can be performed by control system 1310 based on the previous roll value, and a model (e.g. dynamic model) of the air vehicle 10.

In some examples, this command can include generating a command to modify a magnitude of the thrust of the two port secondary propulsion units 200a, 200d.

In some examples, this command can include generating a command to modify a magnitude of the thrust of the starboard secondary propulsion units 200b, 200c.

In some examples, this command can include generating a command to modify tilt of one or more of the forward secondary propulsion units 200c, 200d.

In some examples, this command can include a combination of one or more of the commands recited above.

In some examples, and as explained hereinafter, the air vehicle 10 can include a different number of secondary propulsion units 200. In addition, a number of secondary propulsion units 200 which are tiltable can be different (as explained hereinafter with reference to the non-limitative example of FIGS. 9(a) and 9(b)). The method described above to control roll of the air vehicle 10 can be applied mutadis mutandis, and can include generating commands to vary a ratio of the combined vertical thrust (Tₐᵥ+T_{dv}) provided by the port secondary propulsion units relative to the combined vertical thrust (T_{bv}+T_{cv}) provided by the starboard secondary propulsion units. The command can induce a variation of a magnitude of the thrust (Tₐ, T_{d}) of the port secondary propulsion units and/or a variation of a magnitude of the thrust (T_{b}, T_{c}) of the starboard secondary propulsion units and/or a variation of the tilt (α, β, α′, β′) of the tiltable secondary propulsion units to reach the desired roll angle.

Referring to FIG. 6(c), yaw control of the air vehicle 10 is provided by varying the direction of the thrust vector Vₐ provided by forward secondary propulsion unit 200a relative to the direction of the thrust vector V_{b} provided by forward secondary propulsion unit 200b, i.e., by differentially tilting the secondary propulsion units 200a, 200b about the nominal respective tilt angle zero degree positions. Yaw in one direction is generated when tilt angle α is positive and tilt angle β is negative, such that the respective thrust vectors Tₐ, T_{b} have a forward component and an aft component, respectively, and vice versa. During a pure yaw maneuver, the secondary propulsion units 200 are operated to maintain a balance (in pitch and roll), and the aft secondary propulsion units 200c, 200d and/or the forward secondary propulsion units 200a, 200b can be operated such that the vertical thrust component of combined thrust (Tₐ*cos(α)+T_{b}*cos(β)) of the forward secondary propulsion units 200a, 200b balances that of thrust (T_{c}+T_{d}) of the aft secondary propulsion units 200c, 200d and such that the vertical thrust components of thrusts Tₐ and T_{b} are substantially balanced.

It is to be noted that concurrently with operating the air vehicle 10 to induce a yaw moment, the total vertical thrust T_{totV} provided by the primary propulsion unit 100 (T1) and the four secondary propulsion units 200a, 200b, 200c, 200d (T2_{V}) is concurrently sufficient to take-off, land or hover, or any other VTOL operation it is currently engaged in.

Attention is drawn to FIG. 6 (g), which depicts a method of controlling yaw of the air vehicle 10.

Assume that control system 1310 receives information (e.g. by the flight controller 1050) instructing the air vehicle 10 to change its yaw and to reach a desired yaw value (operation 12000).

The method can include generating (operation 12010) one or more commands to vary a direction of the thrust vector Vₐ provided by forward secondary propulsion unit 200a relative to the direction of the thrust vector V_{b} provided by forward secondary propulsion unit 200b, i.e., by differentially tilting the secondary propulsion units 200a, 200b about the nominal respective tilt angle zero degree positions.

The ratio is modified in order to reach the desired yaw value for the air vehicle 10. Determination of the desired thrust vectors Vₐ, V_{b} can be performed by control system 1310 based on the previous yaw value, and a model (e.g. dynamic model) of the air vehicle 10.

In some examples, and as explained hereinafter, the air vehicle 10 can include a different number of secondary propulsion units 200. In addition, a number of secondary propulsion units 200 which are tiltable can be different. In particular, in some examples, tiltable secondary propulsion units 200 can be present both in front and aft positions of the air vehicle 10 (see e.g. FIGS. 9(a) and 9(b)).

The method described above to control yaw of the air vehicle 10 can be applied mutadis mutandis, and can include generating commands to vary a direction of a thrust vector provided by a plurality of port tiltable secondary propulsion units relative to the direction of the thrust vector provided by starboard tiltable secondary propulsion unit. This can include controlling tilt angles of both front and rear secondary propulsion units 200 (e.g. angles α, β, α′, β′).

In alternative variations of this embodiment in which at least one propulsion unit 200 is mounted to the air vehicle 10 in a manner allowing for the moment arm thereof with respect to the center of gravity CG to be varied, roll control, and/or pitch control and/or yaw control can optionally be provided by varying the ratio of the moment arm of one or more of secondary propulsion unit 200 with respect to the moment arm of the other secondary propulsion unit 200, and/or by suitably varying the ratio of the thrusts.

Assume that pitch of the air vehicle 10 is to be controlled.

According to some examples, in order to obtain nose up pitch, the method can include generating a command to increase length of the booms of the forward second propulsion units 200a, 200b with respect to the length of the booms of the aft secondary propulsion units 200c, 200d. According to some examples, in order to obtain nose down pitch, the method can include generating a command to decrease length of the booms of the forward second propulsion units 200a, 200b with respect to the length of the booms of the aft secondary propulsion units 200c, 200d.

Assume that roll of the air vehicle 10 is to be controlled.

According to some examples, control of roll of the air vehicle 10 can include modifying a length of the booms of the port secondary propulsion units 200a, 200d with respect to a length of the booms of the starboard secondary propulsion units 200b, 200c. Depending on a sign of the desired roll, length of the booms connecting the port secondary propulsion units can be increased with respect to the length of the booms connecting the starboard secondary propulsions unis, or conversely.

Assume that yaw of the air vehicle 10 is to be controlled.

This can include e.g. increasing a length of a boom of one of the forward secondary propulsion unit 200 with respect to a length of the other booms.

### Forward/Aft Motion

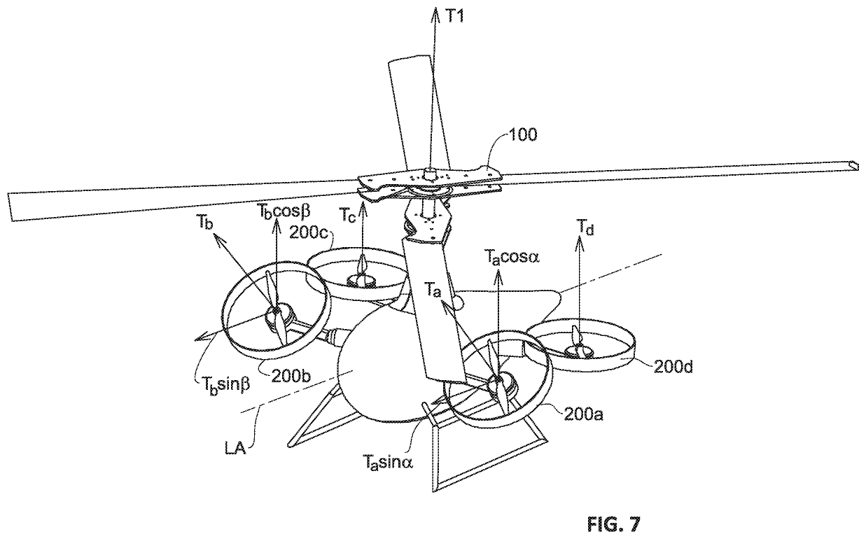

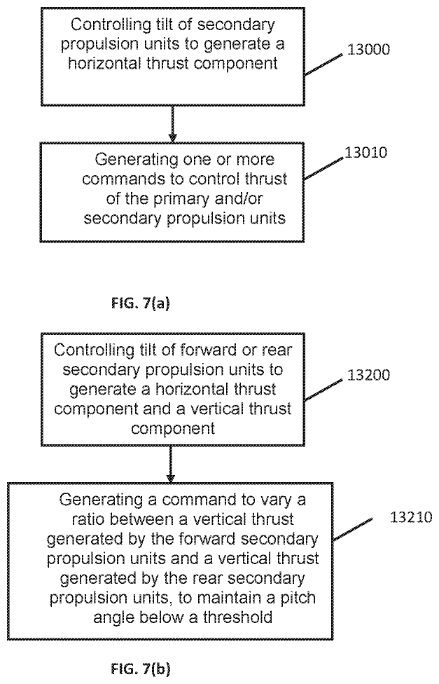

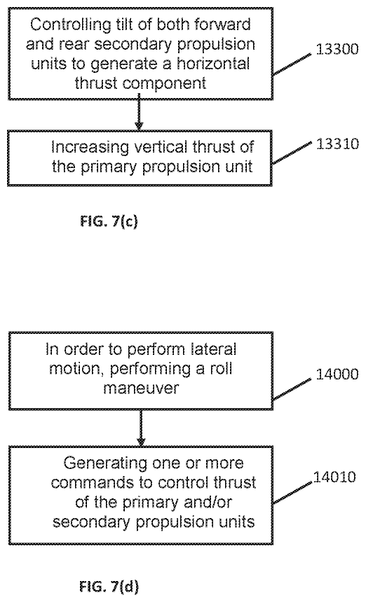

Referring to FIG. 7, forward and aft motion of the air vehicle 100 in hover is provided by varying the direction of the thrust vectors Vₐ, V_{b} of the thrusts Tₐ, T_{b} provided by forward secondary propulsion units 200a, 200b, respectively, in the same manner, i.e., by tilting the two forward secondary propulsion units 200a, 200b in the same direction about the nominal respective tilt angle zero degree positions. Movement in the forward direction is generated when tilt angles α and β are positive, such that the respective thrusts Tₐ, T_{b} both have a forward thrust component Tₐ*sin(α) and T_{b}*sin(β) respectively, and vice versa. The magnitude of the tilt angles α and β are the same if the thrust generated by the two forward secondary propulsion units 200a, 200b are also the same; alternatively, providing different magnitudes for angles α and β can be compensated by providing different magnitudes for the respective thrust Tₐ, T_{b}. During a pure forward or aft maneuver, the propulsion system is operated to maintain a balance (in pitch, roll and yaw), and the aft secondary propulsion units 200c, 200d and/or the forward secondary propulsion units 200a, 200b can be operated such that the vertical thrust component of combined thrust (Tₐ*cos(α)+T_{b}*cos(β)) of the forward secondary propulsion units 200a, 200b balances that of combined thrust (T_{c}+T_{d}) and such that the vertical thrust components of thrusts Tₐ*sin(α) and T_{b}*sin(β) are substantially balanced, and such that the horizontal thrust components Tₐ*cos(α) and T_{b}*cos(β) are substantially balanced.

It is to be noted that concurrently with operating the air vehicle 10 to induce a forward or aft displacement, the total vertical thrust T_{totV} provided by the primary propulsion unit 100 (T1) and the four secondary propulsion units 200a, 200b, 200c, 200d (T2_{V}) is concurrently sufficient to take-off, land or hover, or any other VTOL operation it is currently engaged in.

A method of controlling forward/aft motion of the air vehicle 10 is described with reference to FIG. 7(a).

The method includes generating (operation 13000) a command to control a tilt of e.g. the forward secondary propulsion units 200a, 200b of the air vehicle 10, wherein the tilt is selected to ensure that the forward secondary propulsion units 200a, 200b generate a forward thrust component (horizontal thrust component). For example, the tilt can be selected greater than zero degrees and less than 45 degrees, or up to 90 degrees. The method can include generating a command (operation 13010) to control magnitude of the vertical thrust of the primary propulsion unit 100 and/or of the secondary propulsion units 200. Operation 13010 can be performed to ensure that the total vertical thrust provided by the different propulsion units of the air vehicle 10 is sufficient to balance weight of the air vehicle 10. In some embodiments, a loss in the vertical thrust can be induced by tilting the secondary propulsion units 200, which can be compensated by increasing a magnitude of the thrust of one or more of the secondary propulsion units 200 and/or of the primary propulsion unit 100.

If operation 13000 includes tilting forward secondary propulsion units of the air vehicle 10, this can induce a nose pitch down of the air vehicle 10.

As shown in FIG. 7(b), when the forward secondary propulsion units 200a, 200b are tilted to generate a horizontal thrust component and a vertical thrust component (operation 13200, with a tilt larger than zero degrees and less than 90 degrees), the method can include, in order to maintain a pitch of the air vehicle 10 below a predefined threshold (e.g. substantially equal to zero), generating (operation 13210) a command to vary a ratio between a vertical thrust generated by the forward secondary propulsion units and a vertical thrust generated by the rear secondary propulsion units.

Operation 13210 can include generating a command to vary a ratio between a rpm of secondary rotors of the forward secondary propulsion units and a rpm of secondary rotors of the rear secondary propulsion units to maintain a pitch of the air vehicle 10 below a predefined threshold (e.g. substantially equal to zero).

According to some examples, operation 13210 include increasing a rpm of the forward secondary propulsion units in order to maintain a pitch of the air vehicle 10 substantially equal to zero, or decreasing a rpm of the rear secondary propulsion units in order to maintain a pitch of the air vehicle 10 substantially equal to zero. As mentioned above, in some embodiments, loss of vertical thrust can be compensated by the primary propulsion unit 100.

As explained hereinafter, in some examples (see e.g. FIGS. 9(a) and 9(b)), the rear secondary propulsion units can be tilted (which can therefore induce a nose pitch up). The method of FIG. 7(b) can be applied mutadis mutandis when the rear secondary propulsion units 200c, 200d are tilted to generate a horizontal thrust component and a vertical thrust component, by generating a command to vary a ratio between a vertical thrust generated by the forward secondary propulsion units and a vertical thrust generated by the rear secondary propulsion units to maintain a pitch of the air vehicle 10 below a predefined threshold.

In some examples, if the forward propulsion units 200a, 200b are tilted to generate only a horizontal thrust component (tilt of 90 degrees), a rpm of the rear propulsion units 200c, 200d (untilted) can be set equal to zero to maintain a pitch of the air vehicle 10 substantially equal to zero. A loss in the vertical thrust can be compensated by increasing a total vertical thrust of the primary propulsion unit 100.

Alternatively, if the rear propulsion units 200c, 200d are tilted to generate only a horizontal thrust component (tilt of 90 degrees), a rpm of the front propulsion units 200a, 200b (untilted) can be set equal to zero to maintain a pitch of the air vehicle 10 substantially equal to zero. A loss in the vertical thrust can be compensated by increasing a total vertical thrust of the primary propulsion unit 100.

In some examples, and as explained hereinafter, the air vehicle 10 can include a different number of secondary propulsion units 200, and/or a different number of tiltable secondary propulsion units 200. Therefore, operations 13000/13200 can include generating a control of a tilt of a different number of tiltable propulsion units 200 to generate a horizontal thrust component.

For example (see e.g., FIGS. 9(a) and 9(b)), if the air vehicle 10 includes four tiltable secondary propulsion units (two front propulsion units and two rear propulsion units), the method can include tilting all four propulsion units to generate a horizontal thrust component (see operation 13300 in FIG. 7(c)). In some examples, the same tilt angle can be applied to all secondary propulsion units, in order to keep control of the air vehicle 10. In some examples, a different tilt angle can be applied between the front secondary propulsion units and the rear secondary propulsion units. This difference in the tilt angle can generate undesired motion (e.g., pitch inclination) which can be compensated by changing the rpm of the front secondary propulsion units relative to the rear secondary propulsion units, or conversely. Since the four secondary propulsion units are tilted, the method can include increasing (operation 13310 in FIG. 7(c)) a vertical thrust of the primary propulsion to compensate, at least partially, a loss in vertical thrust generated by the tilt of the secondary propulsion units 200.

### Lateral Motion

Lateral or sideways motion (i.e., in a direction parallel to the pitch axis) of the air vehicle 10 in hover is provided by first inducing a roll maneuver as disclosed above with reference to FIG. 6(a), so that the air vehicle is rolled to a particular roll angle, such that, maintaining this roll angle, each thrust Tₐ, T_{b}, T_{c}, T_{d} now has a lateral force component to provide the desired lateral motion to the air vehicle.

It is to be noted that concurrently with operating the air vehicle 10 to induce a lateral displacement, the total vertical thrust T_{totV} provided by the primary propulsion unit 100 (T1) and the four secondary propulsion units 200a, 200b, 200c, 200d (T2_{V}) is concurrently sufficient to take-off, land or hover, or any other VTOL operation it is currently engaged in.

Attention is drawn to FIG. 7(d).

Assume that control system 1310 receives information (e.g. by the flight controller 1050) instructing the air vehicle 10 to perform a lateral motion (operation 12000).

The method includes generating (operation 14000) one or more commands to change a roll of the air vehicle 10 to a desired roll value.

The method includes generating (operation 14010) one or more commands to control a magnitude of the thrust of the primary propulsion unit 100 and/or of the secondary propulsion units 200. In particular, the vertical thrust can be selected to maintain sufficient lift to the air vehicle 10 during lateral motion.

It is clearly evident that the air vehicle 10 can be operated to provide any suitable forward/aft motion, and/or lateral movement, and/or pitch, and/or yaw, and/or roll, by suitably combining the operations of the secondary propulsion units 200a, 200b, 200c, 200d as disclosed above regarding FIGS. 6(a) to 7. Furthermore, during a pitch and/or roll and/or yaw maneuver, the secondary propulsion units 200a, 200b, 200c, 200d can be operated to maintain the required overall thrust in combination with the primary propulsion unit 100.

Another example of the air vehicle, designated by the reference numeral 10′ and illustrated in FIGS. 9(a) and 9(b), has all the elements and features of the example (and alternative variations thereof) illustrated in FIGS. 1 to 8(d), and is operated in a similar manner thereto, mutatis mutandis, with the following difference. The air vehicle 10′ thus comprises body 300, booms 350, primary propulsion unit 100 and a set of secondary propulsion units 200, substantially similar to body 300, booms 350, primary propulsion unit 100 and a set of secondary propulsion units 200 respectively, as disclosed for the example illustrated in FIGS. 1 to 8(d), and alternative variations thereof, mutatis mutandis.

However, in the example of FIGS. 9(a) and 9(b) the aft secondary propulsion units 200c, 200d of the examples FIGS. 1 to 8(d) are replaced with pivotable (tiltable) aft secondary propulsion units 200c′, 200d′, which can be similar to the pivotable forward secondary propulsion units 200a, 200b.

Thus, in the example of FIGS. 9(a) and 9(b) the aft secondary propulsion units 200c′, 200d′ are further configured for being controllably tilted about a respective pivot axis PA′ (typically parallel to the pitch axis) about tilt angles α′ and β′, respectively, to selectively provide a horizontal thrust vector for providing propulsion in the forward flight direction F, for example.

The angles α′ and β′ can be similar to tilt angles β and α as disclosed herein for the first example, mutatis mutandis.

In alternative variations of this example, the aft secondary propulsion units 200c′, 200d′ can be, additionally or alternatively, configured for being controllably tilted about another pivot axis parallel to the roll axis to provide a horizontal thrust vector in a direction parallel to the pitch axis x to provide yawing moments and/or lateral movements.

The air vehicle 10′ is configured for controllably, selectively and independently varying the thrust vectors of the thrusts Tₐ, T_{b}, T_{c}′, T_{d}′ generated by each of the secondary propulsion units 200a, 200b, 200c′, 200d′, respectively, by the changing tilt angles α, β, α′ and β′ independently from one another. This feature provides at least differential and selective tilt control for the thrust vectors generated by each one of the four secondary propulsion units 200a, 200b, 200c′, 200d′ independently of one another. Nevertheless, the forward secondary propulsion units 200a, 200b can also be operated to tilt together in the same direction and through the same or different angular displacement one from the other, and also the aft secondary propulsion units 200c′, 200d′ can also be operated to tilt together in the same direction and through the same or different angular displacement one from the other. Furthermore, the air vehicle 10′ is configured for controllably and selectively changing the magnitude of the thrust Tₐ, T_{b}, T_{c}′, T_{d}′ generated by each of the secondary propulsion units 200a, 200b, 200c′, 200d′, respectively, independently of one another. The air vehicle 10′ is also configured for controllably and selectively changing the magnitude of the thrust Tₐ, T_{b}, generated by each of the forward secondary propulsion units 200a, 200b, respectively, independently of one another, and also independently of the magnitude of the respective tilt angles α, β thereof, i.e., of the thrust vectors Vₐ and V_{b}, which can also be controllably and selectively varied independently one from the other. The air vehicle 10′ is also configured for controllably and selectively changing the magnitude of the thrust T_{c}′, T_{d}′, generated by each of the aft secondary propulsion units 200c′, 200d′, respectively, independently of one another, and also independently of the magnitude of the respective tilt angles α′, β′ thereof, i.e., of the respective thrust vectors, which can also be controllably and selectively varied independently one from the other

The total vertical thrust T2_{V}′ generated by the set of secondary propulsion units 200 is thus:

T2v′=Tₐᵥ+T_{bv}+T_{cv}+T_{dv}

or

T₂v=(Tₐ*cosine(α))+(T_{b}*cosine(β))+(T_{c}′*cosine(α′))+(T_{d}′*cosine(β′))

Thus, the total vertical thrust T_{totV}′ generated by the air vehicle 10 is:

T_{totV}′=T1+T2v′

Similarly, the total horizontal thrust T2_{H} generated by the set of secondary propulsion units 200, i.e. by the air vehicle 300, is thus:

T2_{H}=(Tₐ*sine(α))+(T_{b}*sine(β))+(T_{c}′*sine(α′))+(T_{d}′*sine(β′))

The air vehicle 10′ is also configured for being operated exclusively in vectored thrust flight mode, within a vectored thrust flight regime, in which the lift, movement and control of the air vehicle 10′ are provided by the primary propulsion unit 100 and the secondary propulsion units 200, under the control of the control system.

For example, for VTOL operations, the secondary propulsion units 200a, 200b, 200c′ and 200d′ are tilted to the nominal vertical position, in which tilt angles α, β, α′, β′ are set at nominally zero degrees, and all four secondary propulsion units 200a, 200b, 200c′, 200d′ provide vertical thrust. In the illustrated embodiment, the center of gravity CG of the air vehicle is located generally centrally with respect to the four secondary propulsion units 200a, 200b, 200c′, 200d′, and thus the four secondary propulsion units 200a, 200b, 200c′, 200d′ can generate nominally the same thrust levels Tₐ, T_{b}, T_{c}′, T_{d}′, for VTOL take-off. At the same time, it is to be noted that the for VTOL operations the primary propulsion unit 100 also provides a vertical thrust T1.

In any case, VTOL operations of the primary propulsion unit 100 and of the secondary propulsion units 200a, 200b, 200c′, 200d′, allows the air vehicle 10′ to vertically take off and to vertically land, to hover over an area, and also to move in a forward or aft direction, and/or to move in a port or starboard side direction, and/or to increase or decrease the altitude of the air vehicle 10′, and/or to provide pitch, yaw and roll control to the air vehicle 10′.

As explained in the various examples above, according to some examples, in order to control operation of the air vehicle according to a desired flight mode, the control system 1310 can in particular rely on a variation of the thrust (in particular vertical thrust T_{2V}) provided by the secondary propulsion units 200, while thrust of the primary propulsion unit 100 (vertical thrust T₁) can be maintained constant. This provides quicker response time and flexibility with respect to a control of the primary propulsion unit 100.

It is to be noted that take-off mode, landing mode and hover mode can be similar as disclosed herein for the first example of the air vehicle 10, mutatis mutandis, in which the tilt angles α′, β′ can +be set at zero degrees.

Furthermore, pitch, yaw and roll control, as well as forward/aft motion, and lateral motion can be similar as disclosed herein for the first example of the air vehicle 10, mutatis mutandis, in which the tilt angles α′, β′ can be set as zero to operate in the same manner as the first example of the air vehicle 10, mutatis mutandis. Alternatively, pitch, yaw and roll control, as well as forward/aft motion, and lateral motion can be enhanced as compared with for the first example of the air vehicle 10, mutatis mutandis, in which the tilt angles α′, β′ can be controlled in a corresponding manner. Various corresponding examples have been described above.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. An air vehicle comprising:
a body;
a primary propulsion unit mounted to the body, said primary propulsion unit including at least one primary rotor and configured for providing at least a majority of a total vertical thrust required for enabling vectored thrust flight to the air vehicle;
a set of secondary propulsion units mounted to the body, said set of secondary propulsion units including at least three said secondary propulsion units, said set of secondary propulsion units being configured for providing variable vectored thrust at least sufficient for generating control moments for stability and control of the air vehicle;
wherein said set of secondary propulsion units comprises at least one said secondary propulsion unit pivotably mounted with respect to said body about a respective pivot axis and configured for pivoting about said pivot axis between at least a vertical mode and a horizontal mode, to respectively provide a thrust vector at least in a range between a vertical thrust vector and a horizontal thrust vector, and wherein said pivotable secondary propulsion units are further configured for providing at least horizontal propulsion to the air vehicle at least when not in vertical mode.

2. The air vehicle according to claim 1, wherein the primary propulsion unit is longitudinally located at or near a center of gravity of the air vehicle.

3. The air vehicle according to claim 1 or claim 2, wherein the primary propulsion unit is transversely located at or near a center of gravity of the air vehicle.

4. The air vehicle according to any one of claims 1 to 3, wherein the primary propulsion unit is configured for being capable of exclusively providing said total vertical thrust.

5. The air vehicle according to any one of claims 1 to 3, wherein the primary propulsion unit is configured for being capable of providing at least 50% of said total vertical thrust.

6. The air vehicle according to any one of claims 1 to 5, wherein the primary propulsion unit is configured for selectively varying thrust generated thereby.

7. The air vehicle according to any one of claims 1 to 6, wherein said at least one respective primary rotor comprises a plurality of respective primary rotor blades and a respective primary rotor shaft.

8. The air vehicle according to claim 7, wherein the primary propulsion system is configured to provide a primary thrust vector aligned with an axis of rotation of the respective primary rotor shaft.

9. The air vehicle according to claim 7 or claim 8, wherein said primary propulsion unit includes two said primary rotors, in contra-rotating relationship with respect to one another, each said rotor comprising a respective plurality of primary rotor blades and a respective primary rotor shaft.

10. The air vehicle according to any one of claims 7 to 9, wherein said primary rotor blades each have a fixed and uniform blade pitch with respect to the respective primary rotor shaft.

11. The air vehicle according to any one of claims 7 to 10, wherein said primary propulsion unit is configured for providing thrust control by changing rpm of the at least one primary rotor.

12. The air vehicle according to any one of claims 1 to 11, comprising four said secondary propulsion units.

13. The air vehicle according to any one of claims 1 to 12, wherein at least two said secondary propulsion units are pivotably mounted with respect to said body about a respective said pivot axis.

14. The air vehicle according to any one of claims 1 to 13, wherein each said secondary propulsion unit is mounted to the body via a respective boom.

15. The air vehicle according to claim 14, wherein said booms projecting outwardly from said body.

16. The air vehicle according to claim 14 or claim 15, wherein said booms are of fixed length.

17. The air vehicle according to claim 14 or claim 15, wherein each said booms is reversibly extending between a retracted configuration and an extended configuration, wherein in the retracted configuration, the respective secondary propulsion unit is closer to the body than in the extended configuration.

18. The air vehicle according to any one of claims 1 to 17, wherein the secondary propulsion units are configured to provide together up to 50% of said total vertical thrust.

19. The air vehicle according to any one of claims 1 to 18, wherein the secondary propulsion units are configured to selectively provide control moments to the air vehicle in at least one of pitch, yaw and roll.

20. The air vehicle according to any one of claims 1 to 19, wherein said primary propulsion unit has a respective primary rotor disc diameter that is significantly larger than a respective secondary rotor disc diameter of each said secondary propulsion units.

21. The air vehicle according to claim 20, wherein said primary rotor disc diameter that is at least 5 times larger than said secondary rotor disc diameter of each said secondary propulsion units.

22. The air vehicle according to any one of claims 20 to 21, wherein a perimeter circumscribed by said primary rotor disc diameter vertically encloses the respective secondary rotor axes of each of the secondary propulsion units.

23. The air vehicle according to any one of claims 20 to 21, wherein a perimeter circumscribed by said primary rotor disc diameter vertically encloses the respective the secondary rotor discs of each of the secondary propulsion units.

24. The air vehicle according to any one of claims 1 to 23, wherein said air vehicle has an absence of fixed wings configured for providing aerodynamic flight to said air vehicle.

25. A control system to control operation of an air vehicle, wherein the air vehicle comprises a primary propulsion unit, and a set of at least three secondary propulsion units including a plurality of tiltable secondary propulsion units, the control system comprising a processing unit and associated memory configured to generate one or more commands comprising:
at least one first command operable to control a magnitude of a thrust of the primary propulsion unit to generate a majority of a total vertical thrust required for enabling vectored thrust flight to the air vehicle,
at least one second command operable to control a variable thrust of the secondary propulsion units, the second command controlling:
a magnitude of a thrust of one or more of the secondary propulsion units, and
a tilt of each of one or more of the tiltable secondary propulsion units along at least one pivot axis, to provide a thrust vector at least in a range between a vertical thrust vector and a horizontal thrust vector.

26. The control system according to claim 25, configured to control an attitude of the air vehicle according to a desired attitude, wherein the at least one second command controlling the secondary propulsion units is operable to control the secondary propulsion units to generate control moments for controlling the air vehicle according to the desired attitude.

27. The control system according to claim 25 or claim 26, configured to:
generate a command inducing a tilt of one or more of the secondary propulsion units to generate a thrust vector including a horizontal thrust component, the command inducing a decrease of a magnitude of a total vertical thrust generated by the secondary propulsion units, and
generate a command to increase the total vertical thrust of the primary propulsion unit, to compensate at least partially said decrease.

28. The control system according to claim 27, wherein the air vehicle includes front tiltable secondary propulsion units and rear tiltable secondary propulsion units, wherein the control system is configured to generate a command to tilt both the front tiltable secondary propulsion units and the rear tiltable secondary propulsion units to each generate a thrust vector including a horizontal thrust component, thereby inducing a decrease of a magnitude of a total vertical thrust generated by the secondary propulsion units, and to generate a command to increase a total vertical thrust of the primary propulsion unit to compensate at least partially said decrease.

29. The control system according to any of claims 25 to 28, configured to generate at least one command operable to increase a total vertical thrust generated by the air vehicle to induce ascent of the air vehicle, wherein a majority of the increase of the total vertical thrust results from an increase of a total vertical thrust generated by the secondary propulsion units.

30. The control system according to any of claims 25 to 29, configured to generate at least one command operable to increase a magnitude of a total vertical thrust of the secondary propulsion units, while maintaining a vertical thrust of the primary propulsion unit, for controlling an ascent of the air vehicle.

31. The control system according to any of claims 25 to 30, wherein the air vehicle comprises forward secondary propulsion units and rear secondary propulsion units, the control system being configured to perform at least one of (1) and (2):
(1) generate a command inducing a tilt of forward secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold,
(2) generate a command inducing a tilt of rear secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold.

32. The control system according to any of claims 25 to 31, configured to vary a ratio between a rpm of secondary rotors of forward secondary propulsion units and a rpm of secondary rotors of rear propulsion units to maintain a pitch of the air vehicle below a predefined threshold.

33. The control system according to any of claims 25 to 32, configured to generate at least one command operable to decrease a total vertical thrust generated by the air vehicle to induce descent of the air vehicle, wherein a majority of the decrease of the total vertical thrust results from a decrease of a total vertical thrust generated by the secondary propulsion units.

34. The control system according to any of claims 25 to 33, configured to generate at least one command operable to decrease a magnitude of a total vertical thrust of the secondary propulsion units, while maintaining a vertical thrust of the primary propulsion unit, for controlling a descent of the air vehicle.

35. The control system according to any of claims 25 to 34, wherein the secondary propulsion units are shifted from the primary propulsion unit along a yaw axis of the air vehicle.

36. The control system according to any of claims 25 to 35, configured to generate a command to control a vertical thrust of the primary propulsion unit to at least balance weight of the air vehicle.

37. The control system of any of claims 25 to 36, configured to, during a take-off of the air vehicle:
generate at least one first command controlling total vertical thrust of the primary propulsion unit to be at least equal to a first threshold,
generate at least one second command to
control a tilt of each of the tiltable secondary propulsion units to generate a vertical thrust vector,
control a magnitude of a total vertical thrust of the secondary propulsion units to be above a second threshold,
wherein the first threshold and the second threshold correspond to a flight mode in which a total vertical thrust of the air vehicle balances a weight of the air vehicle.

38. The control system of any of claims 25 to 37, configured to, during a descent of the air vehicle:
generate at least one first command controlling total vertical thrust of the primary propulsion unit to be at least equal to a first threshold,
generate at least one second command to
control a tilt of each of the tiltable secondary propulsion units to generate a vertical thrust vector, and
control a magnitude of a total vertical thrust of the secondary propulsion units to be below a second threshold,
wherein the first threshold and the second threshold correspond to a flight mode in which a total vertical thrust of the air vehicle balances a weight of the air vehicle.

39. The control system of any of claims 25 to 38, configured to generate at least one command to maintain an altitude of the air vehicle, the at least one command being operable to control:
a magnitude of a vertical thrust generated by the primary propulsion unit, and
a magnitude and a tilt of the secondary propulsion units to generate a total vertical thrust by the secondary propulsion units,
wherein the vertical thrust of the primary propulsion unit and the total vertical thrust of the secondary propulsion units balance weight of the air vehicle.

40. The control system according to any one of claims 25 to 39, configured to generate a command of the secondary propulsion units to selectively provide control moments to the air vehicle in at least one of pitch, yaw and roll.

41. The control system of any of claims 25 to 40, wherein each said secondary propulsion unit is mounted to a body of the air vehicle via a respective boom, the control system being configured to generate a command to control a length of one or more booms of the air vehicle to generate control moments controlling the air vehicle.

42. The control system of any of claims 25 to 41, configured to perform at least one of (1), (2) and (3):
(1) control a pitch of the air vehicle, the control including generating a command to vary a ratio of combined vertical thrust provided by aft secondary propulsion units relative to a combined vertical thrust provided by forward propulsion units;
(2) control a roll of the air vehicle, the control including generating a command to vary a ratio of combined vertical thrust provided by port secondary propulsion units relative to a combined vertical thrust provided by starboard propulsion units;
(3) control a yaw of the air vehicle, the control including generating a command to vary a direction of a thrust vector provided by port secondary propulsion vectors relative of a thrust vector provided by starboard secondary propulsion units.

43. An air vehicle comprising a primary propulsion unit, and a set of at least three secondary propulsion units including a plurality of tiltable secondary propulsion units, and the control system according to any of claims 25 to 42.

44. A method of controlling operation of an air vehicle, wherein the air vehicle comprises a primary propulsion unit, and a set of at least three secondary propulsion units including a plurality of tiltable secondary propulsion units, the method comprising, by a processing unit and associated memory operatively coupled to the air vehicle:
generating at least one first command operable to control a magnitude of a thrust of the primary propulsion unit to generate a majority of a total vertical thrust required for enabling vectored thrust flight to the air vehicle,
generating at least one second command operable to control a variable thrust of the secondary propulsion units, the second command controlling:
a magnitude of a thrust of one or more of the secondary propulsion units, and
a tilt of each of one or more of the tiltable secondary propulsion units along at least one pivot axis, to provide a thrust vector at least in a range between a vertical thrust vector and a horizontal thrust vector.

45. The method according to claim 44, comprising controlling an attitude of the air vehicle according to a desired attitude, wherein the at least one second command controlling the secondary propulsion units is operable to control the secondary propulsion units to generate control moments for controlling the air vehicle according to the desired attitude.

46. The method according to claim 44 or to claim 45, comprising:
generating a command inducing a tilt of one or more of the secondary propulsion units to generate a thrust vector including a horizontal thrust component, the command inducing a decrease of a magnitude of a total vertical thrust generated by the secondary propulsion units, and
generating a command to increase the total vertical thrust of the primary propulsion unit, to compensate at least partially said decrease.

47. The method according to any of claims 44 to 46, comprising performing at least one of (1) and (2):
(1) generating at least one command operable to increase a total vertical thrust generated by the air vehicle to induce ascent of the air vehicle, wherein a majority of the increase of the total vertical thrust results from an increase of a total vertical thrust generated by the secondary propulsion units,
(2) generating at least one command operable to decrease a total vertical thrust generated by the air vehicle to induce descent of the air vehicle, wherein a majority of the decrease of the total vertical thrust results from a decrease of a total vertical thrust generated by the secondary propulsion units.

48. The method according to any of claims 44 to 47, comprising performing at least one of (1) and (2):
(1) generating at least one command operable to increase a magnitude of a total vertical thrust of the secondary propulsion units, while maintaining a vertical thrust of the primary propulsion unit, for controlling an ascent of the air vehicle;
(2) generating at least one command operable to decrease a total vertical thrust generated by the air vehicle to induce descent of the air vehicle, wherein a majority of the decrease of the total vertical thrust results from a decrease of a total vertical thrust generated by the secondary propulsion units.

49. The method according to any of claims 44 to 48, wherein the air vehicle comprises forward secondary propulsion units and rear secondary propulsion units, the method comprising performing at least one of (1) and (2):
(1) generating a command inducing a tilt of forward secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold,
(2) generating a command inducing a tilt of rear secondary propulsion units to generate a thrust vector including a horizontal thrust component and a vertical thrust component, and generate a command to vary a ratio between a vertical thrust generated by the forward secondary propulsion units and a vertical thrust generated by the rear secondary propulsion units, to maintain a pitch of the air vehicle below a predefined threshold.

50. A non-transitory storage device readable by a machine, tangibly embodying a program of instructions executable by the machine to perform operations of controlling operation of an air vehicle, wherein the air vehicle comprises a primary propulsion unit, and a set of at least three secondary propulsion units including a plurality of tiltable secondary propulsion units, the operations comprising, by the machine:
generating at least one first command operable to control a magnitude of a thrust of the primary propulsion unit to generate a majority of a total vertical thrust required for enabling vectored thrust flight to the air vehicle,
generating at least one second command operable to control a variable thrust of the secondary propulsion units, the second command controlling:
a magnitude of a thrust of one or more of the secondary propulsion units, and
a tilt of each of one or more of the tiltable secondary propulsion units along at least one pivot axis, to provide a thrust vector at least in a range between a vertical thrust vector and a horizontal thrust vector.
